(19) United States
(12) Patent Application Publication
(10) Pub. No.: US 2007/0244779 A1
(43) Pub. Date: Oct. 18, 2007

(54) BUSINESS TO BUSINESS FINANCIAL TRANSACTIONS

(76) Inventor: Ran Wolff, Geva-Carmel (IL)

Correspondence Address: FISH & RICHARDSON P.C., P.O. BOX 1022, MINNEAPOLIS, MN, 55440-1022, US

(21) Appl. No.: 11/692,647

(22) Filed: Mar. 28, 2007

Related U.S. Application Data
(60) Provisional application No. 60/743,834, filed on Mar. 28, 2006.

(51) Int. Cl. G06Q 40/00

(52) U.S. Cl. 705/35

(57) ABSTRACT

In an aspect of the invention, a system and method are provided for facilitating short-term loans between businesses, secured against receivables. For example, if a business A owes a debt to business B, then A can lend money to B or to a third business C to whom B is in debt. Thus, a loan that defaults can be deducted from an existing debt. In another aspect, a system and method are providing for nullifying debt between businesses. For example, if business A owes an amount to business B and B owes to A, the smaller debt between the parties can be nullified, leaving one debt between A and B. In other implementations, a search can be performed for linking debts that allow a business A, for example, to nullify (or reduce) a given debt it owes to business Z.

### CROSS-REFERENCE TO RELATED APPLICATION(S)

This application claims the benefit of priority under 35 U.S.C. §119(e) of U.S. Provisional Patent Application Ser. No. 60/743,834, filed on Mar. 28, 2006, the contents of which are hereby incorporated by reference.

### TECHNICAL FIELD

This disclosure relates to business to business financial transactions.

### BACKGROUND

Businesses manage their cash flow on a regular, often daily, basis. Generally, a business checks what prospective income and expense it has on a given day. If there is more income then expense, the excess sum often is deposited in a bank account to earn modest interest. If there is a shortage of income compared to expense, the business can address this shortage in several ways. For a small group of extremely credit-worthy businesses, an option is to issue commercial papers against short-term debt. Sometimes a business might be able to withdraw the shortfall from its cash assets. A business might even resort to selling its receivables (commonly known as “factoring”). However, oftentimes, such a shortage is managed by a short-term loan from a bank secured by the business's receivables (commonly known as “asset-based lending”). The interest rate on such short term loans usually is significantly higher (e.g., by 2% to 20%, depending on the business) than the interest paid by the bank on the business's deposits.

The cost of liquidity is determined by the risk involved. The basic cost of liquidity is the Prime interest rate. Most businesses, especially the smaller and less credit-worthy ones, would pay at least the Prime rate, even if the loan is secured against receivables. However, the maturity of the receivable used as security, and the credit worthiness of the originator can have a large effect on the interest rate. For example, a receivable from a blue-chip company due to be paid in less than 30 days to a credit worthy originator may lower the cost of liquidity to just slightly above the London Interbank Offered Rate or “LIBOR” (e.g., about 5.32%), whereas receivables from less credit-worthy companies may disqualify as securities altogether, or increase the cost, for example, to as much as twice the Prime rate.

### SUMMARY

In an aspect of the invention, a system and method are provided for facilitating short-term loans between businesses, secured against receivables. For example, if a business A owes an amount to another business B, then A can lend money to a either B or a third business C to whom B is in debt. In this manner, a loan that defaults can be deducted from an existing debt. Due to this methodology of managing risk, some implementations facilitate short-term loans having interest rates lower than the prevailing Prime interest rate.

In another aspect of the invention, a system and method are providing for nullifying debt between businesses. For example, if business A owes an amount to business B and B owes to A, then the smaller debt between the parties can be nullified, leaving one debt between A and B. In other implementations, a search can be performed for linking debts that allow a business A, for example, to nullify (or reduce) a given debt it owes to business Z. In still other implementations, a search can be performed prior to the creation of a debt to assist a business in choosing a vendor. For example, a business may be able to identify a vendor that can be paid, in whole or in part, by nullifying an existing accounts receivable.

The details of one or more embodiments are set forth in the accompanying drawings and the description below. Other features and advantages will be apparent from the description and drawings, and from the claims.

### BRIEF DESCRIPTION OF DRAWINGS

FIG. 1 is a schematic of an implementation of a system for business to business banking.

FIG. 2 is an illustrative structure of debts between businesses.

FIGS. 3A-3D are flow diagrams illustrating implementations of methods for extending loans from one business to another.

FIGS. 4A-4D illustrate examples of ways in which a loan can be finalized between businesses.

FIGS. 4E-4F illustrate examples of loans in default.

FIG. 5A is a flow diagram illustrating an implementation of a method for nullifying (or reducing) debt between businesses.

FIG. 5B is a flow diagram illustrating an implementation of a second method for nullifying (or reducing) debt between businesses.

FIGS. 6A and 6B illustrate examples of ways in which a nullification (or reduction) can be finalized between businesses.

FIGS. 7A-7F illustrate examples of business to business banking.

### DETAILED DESCRIPTION

The following is a description of various implementations, as well as some alternative implementations, of a system and method for business to business banking.

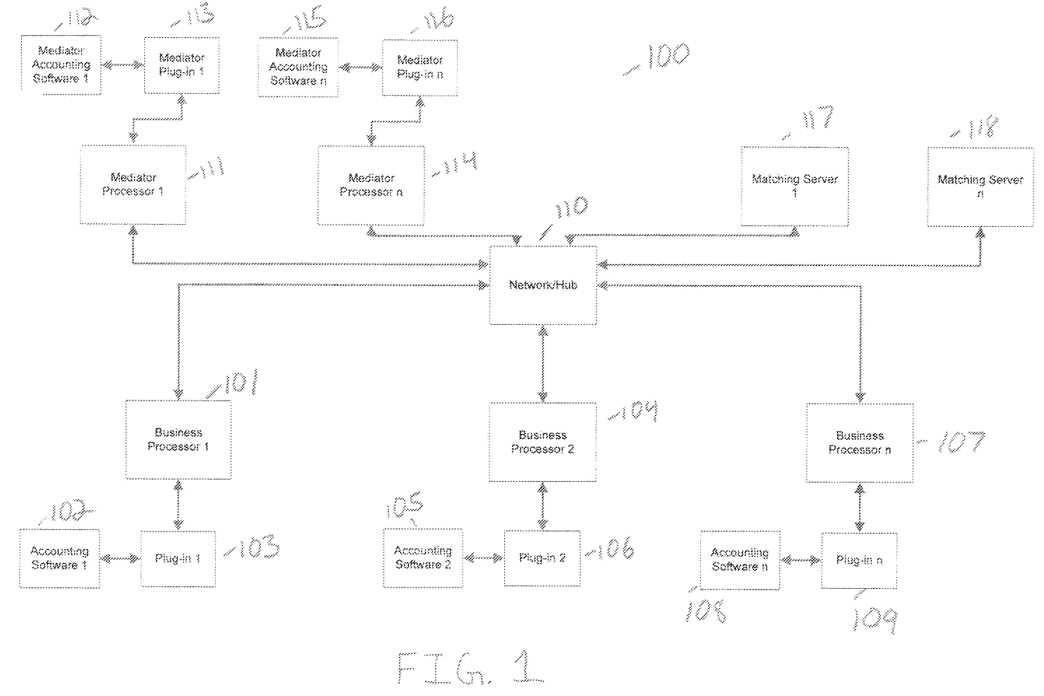

Generally, banks serve thousands of accounts. The cumulative deposits in the debiting accounts of banks are invested in loans in its crediting accounts. Businesses generally manage their credit similarly, balancing credit they get from suppliers against credit they provide their customers. However, a business usually manages many fewer accounts than a bank does. Thus, a business with a given sum of money is not very likely to find among its suppliers one which is in need of an advancement. Nor is a business with a debt that it seeks to nullify likely to find a directly offsetting receivable. In FIG. 1, an implementation of a system 101 is illustrated that can address these problems by, among other things, searching deeper into the network of businesses (e.g., suppliers and customers). By expanding the search along the lines of credits from one business to the next, the system 101 can increase the overall capacity for debt and credit.

The system 100 includes three classes of participants. First are the business entities. In this illustration, each of the business processors 101, 104 and 107 are each associated with a business. The system 1001 can include any number of business processors, from 1 or 2 up to “n”, where n is any positive integer (see item 107—“Business Processor n”). The next class of participants is the matching servers 117 and 118. There can be any number of matching servers, e.g., up to “n” (see item 118—“Matching Server n”). Matching servers 117 and 118 analyze the financial data of businesses (e.g., those associated with the business processors 101, 104 and 107) and identify matching debts or credits. The last class of participants, which is optional in most implementations, is the mediators. Each mediator has associated therewith a mediator processor. To illustrate that there can be any number of mediators and associated mediator processors, a first mediator processor 111 and an nth mediator processor 114 are shown. Mediators, when they are employed, orchestrate certain aspects of the loans extended between businesses to simplify the lending/borrowing process. In some implementations, mediators draw a commission for their services. Inter-class and intra-class communication is handled by the network/hub 110. Each of these classes will be discussed in greater detail below.

Facilitating Loans Between Businesses

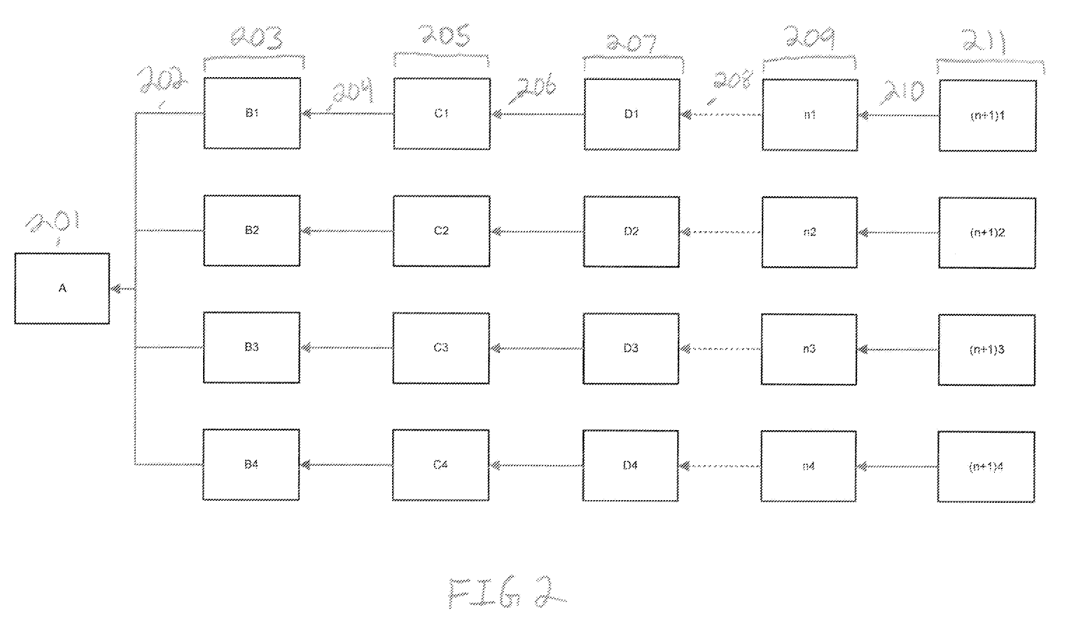

Prior to disclosing details of a particular implementation for facilitating loans between businesses, it is instructive to discuss an example of a structure of businesses indebted to each other. FIG. 2 illustrates such a structure, in which each arrow represents a debt. The party at the arrowhead is the creditor and the party at the tail is the debtor. In this example, business A (201) is a party who desires a loan or nullification (or reduction) of a debt. Business A has extended credit to businesses B1 through B4 (203). Debts 202 are referred to as primary debts, and B1 through B4 (203) are referred to as primary debtors. Each of businesses B1 through B4 (203) has extended credit to businesses C1 through C4 (205). These debts 204 are referred to as secondary debts, and C1 through C4 (205) are referred to as secondary debtors. Each of businesses C1 through C4 (205) has extended credit to businesses D1 through D4 (207). These debts 206 are referred to as tertiary debts, and D1 through D4 (207) are referred to as tertiary debtors. The line of debts and debtors can continue ad infinitum, e.g., through a chain of debts including 208 and 210. For example, the line may continue until businesses n1 through n4 (209), each having extended nth credit 210 to (n+1) businesses 211. Thus, the chain 208 may include additional debtors and creditors. For ease of illustration, four businesses are shown as being within each tier of debt (e.g., primary, secondary, tertiary, etc.). However, in other cases, each tier can include anywhere from one to n businesses. Furthermore, a debtor on any of the tiers can be, at the same time, a debtor or a creditor on the same or another tier at some other chain of debt, or even at the same one.

Each business, except for A, is given a numerical suffix, e.g., B1, C1, D1, etc. This is to indicate that those parties with the same numerical suffix are on the same chain of debt. Put another way, these parties can be conceptualized as being connected to each other by debts (e.g., D1 owes C1 who owes B1). A party may be on multiple chains (such as business A), but for ease of illustration, each tier of debtors (203, 205, 207, 209 and 211) is on one chain of debt. For example, D1 also may owe C2. In that case, D1, C2, B2 and A are part of a chain.

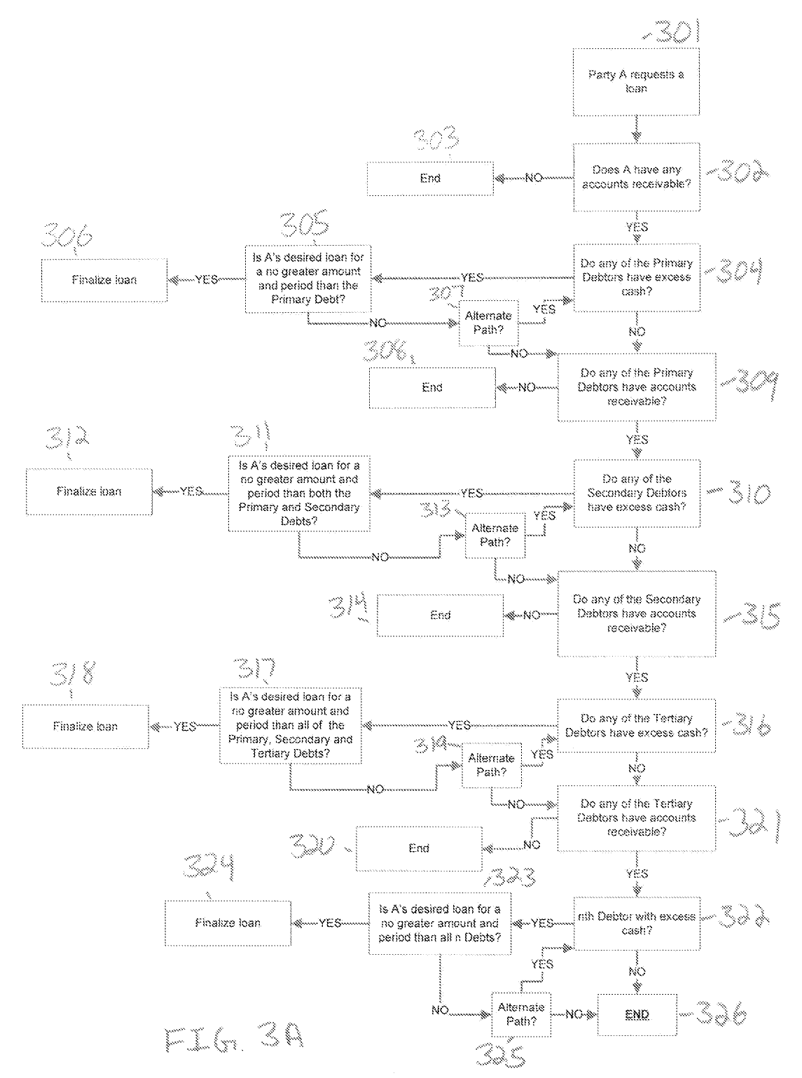

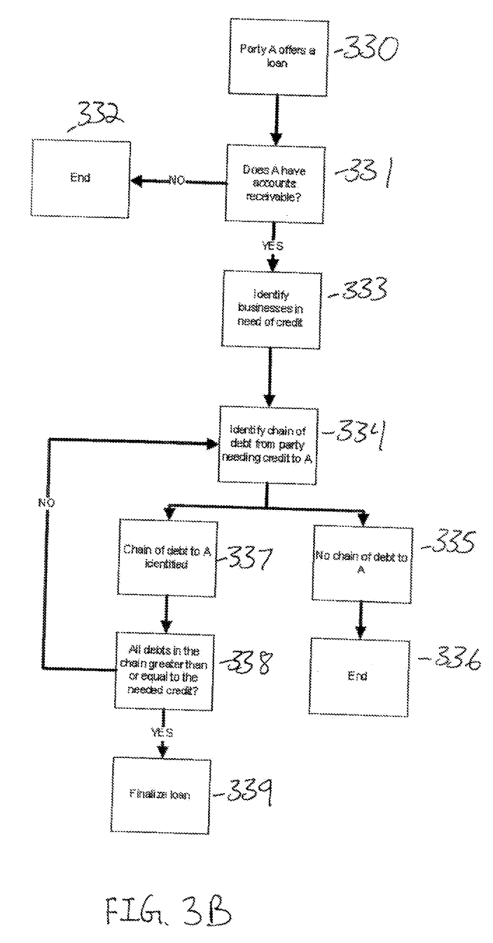

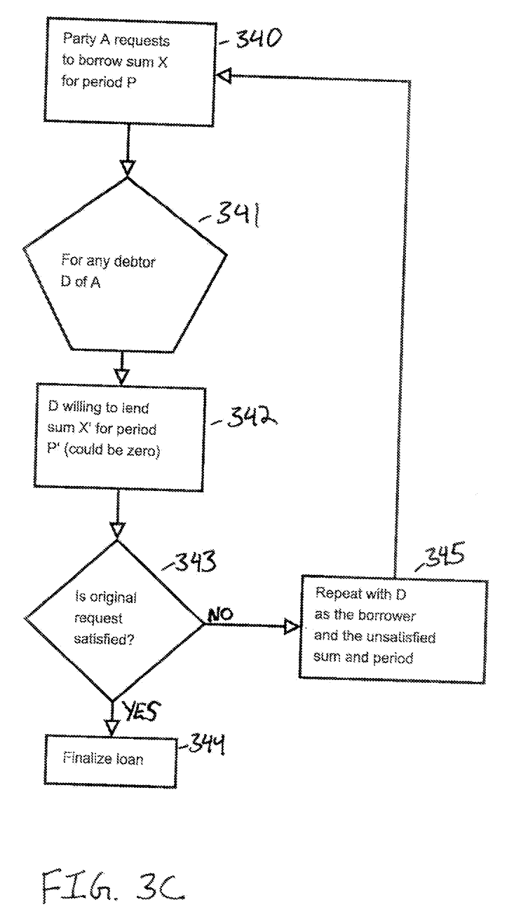

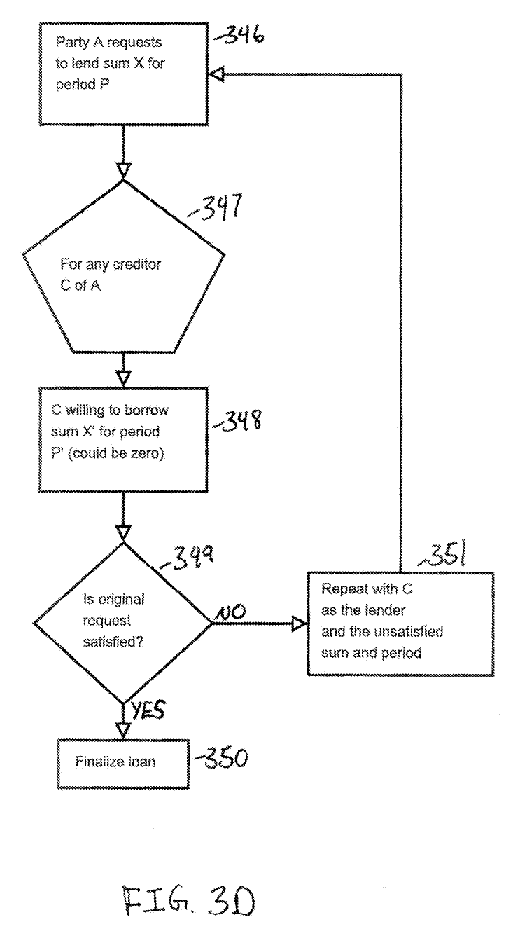

FIG. 3A illustrates an implementation of a method for facilitating a loan from one business to another. This illustration is from the perspective of a party who desires a loan (301); processes for a party who wishes to extend a loan are discussed in connection with FIGS. 3B and 3D. Also, this method can be implemented by, for example, the system 100 of FIG. 1.

It is first determined if the party who desires a loan (i.e., business A) has any accounts receivable (302). Since accounts receivable are the basis for securing loans in this implementation, if A has no accounts receivable against which to secure a loan(s), the process ends (303). If, however, A does have accounts receivable, it is determined whether any of the primary debtors (e.g., tier 203 of FIG. 2 who are A's debtors) have excess cash for lending.

If a primary debtor does have excess cash for lending, it is determined (305) whether A's requested loan is for an amount and period no greater than the amount and remaining period of the primary debt (e.g., item 202 of FIG. 2). In this implementation, it is preferred that A's accounts receivable fully securitize the requested loan. Therefore, the loan that A requests from its debtor(s) must be for an amount and period of time no greater than that of the debt the debtor(s) owe to A. If business A's requested loan meets these requirements, the next block is to finalize the loan (306). Several debtors may be able to provide the loan. For example, it may be that debtors B1 and B2 of FIG. 2 could provide a suitable loan given the result of block 305. Block 305 can be iterated so as to identify all possible lenders from those identified in block 304. As such, block 306 can include the process of presenting A with options vis-à-vis potential lenders, along with certain data that may assist in making a decision. Moreover, it is not necessary that the process end at block 306. The process, after identifying possible loans at block 306, can continue to block 309 in an attempt to identify lenders in other tiers (e.g., items 205, 207, 209 and/or 211 of FIG. 2).

If the requested loan does not meet the parameters, it is determined whether an alternate path is available (307). For example, it may be that debtor B2 of FIG. 2 has excess cash for lending, but the debt owed by B2 to A is either too small in size or period to cover the requested loan. In the case of FIG. 2, the method would return to block 304 and analyze debtors B3 and B4. The alternate path block 307 does not, in most implementations, cause block 304 to re-analyze a debtor already analyzed. If there are no alternate paths available (e.g., the last available primary debtor with available cash does not owe a debt to A that can cover the requested loan), the process proceeds to block 309 to identify a potential lender in a subsequent tier.

If, at block 309, it is determined that none of the primary debtors has accounts receivable, the process ends (308). Since no primary debtors have debts to A, and there are no debts owed to any primary debtors, there exists no chain of debts to A that can secure the requested loan. When the process reaches “end” blocks 308, 314, 320, or 326, it does not necessarily mean that no loans have been identified, but simply that the process has reached the end of available options.

In some implementations, (e.g., to avoid not being able to provide a loan to A) a variation on the alternate path block 307 is available. If the debt owed by a primary debtor to A is either too small in size or duration to cover the requested loan, the method can create a loan that will cover part of the requested loan. The method can assemble these partial loans together to satisfy some or all of the loan requested by business A. Examples of implementations that create partial loans are also illustrated in FIGS. 3C and 3D.

If some of the primary debtors have accounts receivable, it is determined (310) if any of the secondary debtors (e.g., tier 205 of FIG. 2, who are B1-B4's debtors) have excess cash for lending.

If a secondary debtor does have excess cash for lending, it is determined (311) whether A's requested loan is for an amount and period no greater than the amount and remaining period of the primary debt owed to A (e.g., from B1 of FIG. 2) and the secondary debt owed to the primary debtor (e.g., from C1 of FIG. 2). Using B1 and C1 as an example, in this implementation, it is preferred that A and B1's accounts receivables fully securitize the requested loan. Therefore, the loan that A desires from the secondary debtor must be for an amount and period no greater than the amount and remaining period of the debts in the chain (i.e., those that are owed from C1 to B1 and from B1 to A). If A's requested loan meets these parameters, the next block is to finalize the loan (312). Several debtors may be able to provide the loan. For example, it may be that debtors C1 and C2 of FIG. 2 could provide a suitable loan given the result of block 311. Block 311 can be iterated so as to identify all possible lenders from those identified in block 310. As such, block 312 can include the process of presenting A with options vis-à-vis potential lenders, along with certain data that may assist in making a decision. Moreover, it is not necessary that the process end at block 312. The process, after identifying possible loans at block 312, can proceed to block 315 in an attempt to identify lenders in other tiers (e.g., items 207, 209 and/or 211 of FIG. 2).

If the requested loan does not meet the parameters, it is determined whether an alternate path is available (313). For example, it may be that debtor C2 of FIG. 2 has excess cash for lending, but the debt owed by B2 or C2 is either too small in size or period to cover the requested loan. In the case of FIG. 2, the method would return to block 310 and analyze debtors C3 (and B3) and C4 (and B4). The alternate path block 313 does not, in most implementations, cause block 310 to re-analyze a debtor already analyzed. If there are no alternate paths available (e.g., (1) the last available secondary debtor with available cash does not owe a debt to a primary debtor that can cover the requested loan and/or (2) the primary debtor associated with the last available secondary debtor with available cash does not owe a debt to A that can cover the requested loan), the process proceeds to block 315 to identify a potential lender in a subsequent tier.

If, at block 315, it is determined that none of the secondary debtors has accounts receivable, the process ends (314). Since there are (1) no debts owed by primary debtors to A, (2) there are no debts owed to any primary debtors and (3) there are no debts to any secondary debtors, there exists no chain of debts to A that can secure the requested loan.

In some implementations, (e.g., to avoid not being able to provide a loan to A) a variation on the alternate path block 313 is available. If the debt owed by a primary debtor to A or from the secondary debtor to the primary debtor is either too small in size or period to cover the requested loan, the method can create one or more loans each of which will cover part of the requested loan. The method can assemble these partial loans together to satisfy some or all of the loan requested by A. Examples of implementations that create partial loans are also illustrated in FIGS. 3C and 3D.

The blocks associated with tertiary debtors, e.g., blocks 316-320 are analogous to the respective blocks associated with secondary debtors, and therefore, will not be discussed in detail.

The method can continue until any n tiers of debtors. If some of the tertiary or (n−1)th debtors have accounts receivable, it is determined (322) whether any of the nth debtors (e.g., tier 209 of FIG. 2) has excess cash for lending.

If an nth debtor does have excess cash for lending, it is determined (323) whether A's requested loan is for an amount and period no greater than the amount and remaining period of the debts in the chain toward A. Using (n+1)1, n1, D1, C1 and B1 of FIG. 2 as an example, in this implementation, it is preferred the accounts receivable of business A, B1, C1, D1 and n1 fully securitize the requested loan. Therefore, the loan that business A desires from the secondary debtor preferably is for an amount and period no greater than the amount and remaining period of the debts that are owed from (n+1)1 to n1, from n1 through the chain to D1, from D1 to C1, from C1 to B1 and from B1 to business A. If A's requested loan meets these requirements, the next block is to finalize the loan (324). Several debtors may be able to provide the loan. For example, it may be that debtors n1 and n3 of FIG. 2 could provide a suitable loan given the result of block 323. Block 323 can be iterated so as to identify all possible lenders out of those identified in block 322. As such, block 324 can include the process of presenting business A with options vis-à-vis potential lenders, along with certain data that may assist in making a decision.

If the requested loan does not meet the parameters, it is determined whether an alternate path is available (325). For example, it may be that debtor n2 of FIG. 2 has excess cash for lending, but the debt owed by B2, C2, or D2 is either too small in size or period to cover the requested loan. In this implementation, the method determines whether there are other paths available to identify a lender. In the case of FIG. 2, the method would return to block 322 and analyze debtors n3 (and D3, C3 and B3) and n4 (and D4, C4 and B4). The alternate path block 325 does not, in most implementations, cause block 322 to re-analyze a debtor already analyzed. If there are no alternative paths available, the process ends at block 326. If, at block 322, it is determined that none of the nth debtors has excess cash, the process ends (314).

FIG. 3B illustrates an implementation of a method for finding a borrower for a lender who offers to extend a loan (330). It is first determined whether A has any accounts receivable (331). If it does not, the process ends (332) because there exists no receivables to secure the loan. If A does have accounts receivable, businesses are identified that need credit (333). It is then determined (334) whether there is a chain of debt from the party needing credit to A. If there is no chain (335) the process ends (336). If there is a chain (337), it is determined whether all debts in the chain have an amount and a period no less than the amount and the period of the credit needed (338). If there is a fault (e.g., one of the debts in the chain is for an insufficient amount o in the chain, the method returns to block 334 to identify a different chain. This loop continues until either a usable chain is identified, or it is determined that no chain exists (335) and the process ends (336). If a usable chain is identified, the loan is finalized (339).

FIG. 3C illustrates an implementation of a method for party A who requests to borrow a sum X for a period P (340). The first block is to identify the debtors of A (341). Of the debtors, one is identified who is willing to lend a certain sum (X′) for a certain period (P′). The certain sum X′ can be less than X, and the period P′ can be less than P. In fact, X′ and P′ may be zero. Given the loan identified in block 342, block 343 determines whether the original request for a sum X for a period P has been satisfied. If it has not, block 345 repeats the process with the party identified in block 342 as the borrower. The sum X then becomes the amount of original request X that has not been satisfied, and the period P becomes the amount of the original period P that has not been satisfied. Once the original request has been satisfied—and it may involve recursive block 345 any number of times—the loan (or loans) is finalized 344.

FIG. 3D illustrates an implementation of a method for party A who requests lending a sum X for a period P (346). The first block is to identify the creditors of A (347). Of the creditors, one is identified who is willing to borrow a certain sum (X′) for a certain period (P′). The certain sum X′ can be less than X, and the period P′ can be less than P. In fact, X′ and P′ may be zero. Given the loan identified in block 348, block 349 determines whether the original request for lending a sum X for a period P has been satisfied. If it has not, block 351 repeats the process with the party identified in block 348 as the lender. The sum X then becomes the amount of original request X that has not been satisfied, and the period P becomes the amount of the original period P that has not been satisfied. Once the original request has been satisfied—and it may involve recursive block 351 any number of times—the loan (or loans) is finalized 350.

Depending on the implementation, the determinations at blocks 302, 304-307, 309-313, 315-319, 321-325, 331, 333-335, 337-339, 341-345 and 347-351 (and others like it) can be made by, e.g., a matching server (items 117 or 118 of FIG. 1) interfacing with a business server (items 104, 105 and/or 107 of FIG. 1) associated with a debtor to analyze its accounting data.

Examples of Finalizing a Loan Between Businesses

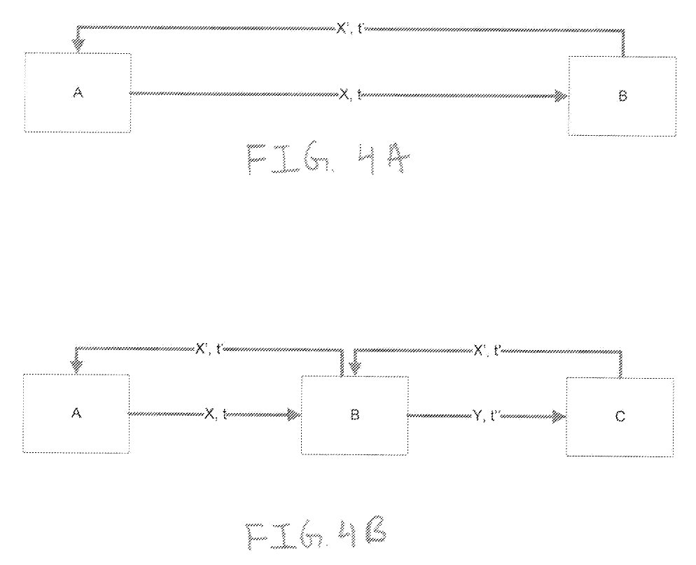

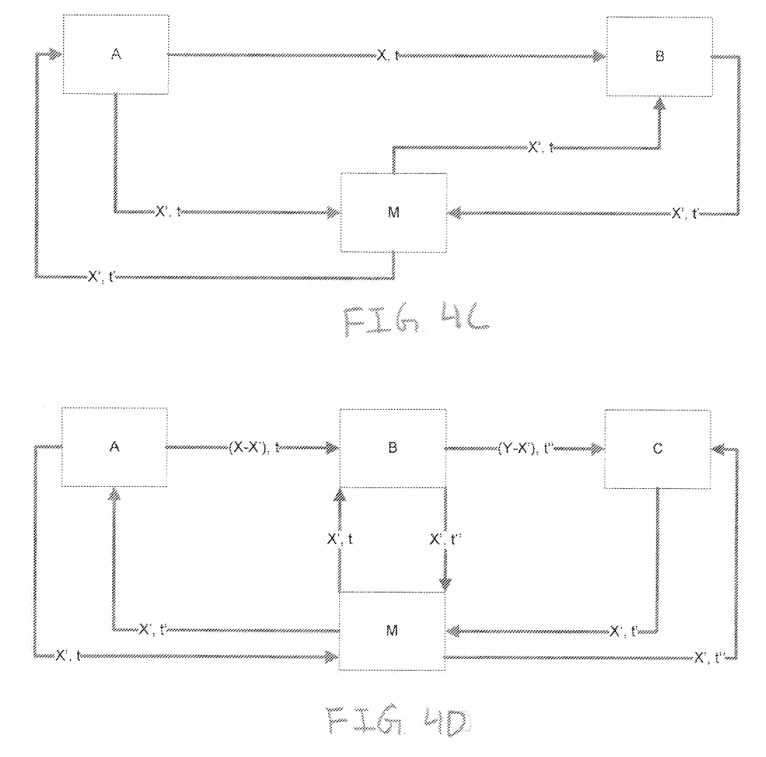

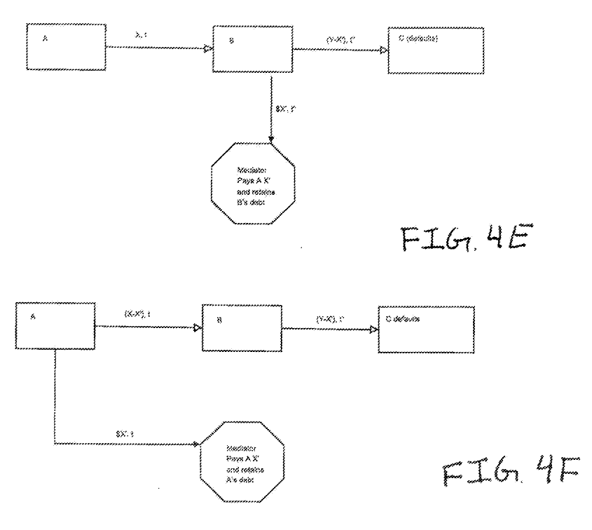

FIG. 4A illustrates a simple case of a business to business loan. The arrows indicate debts, with creditor at the arrowhead and the debtor at the tail. Each debt has an amount and period associated with it, illustrated in the format of [X, t], where “X” represents the amount and “t” represents the period (i.e., the remaining time until the debt becomes due). In this example, it is assumed that business A bought some product from a second business B. In connection with that purchase, it is presumed that A agreed to pay one million dollars within 120 days to B (i.e., X=$1,000,000 and t=120 days). During this period of the debt, it is assumed that A incurs a surplus of $100,000 cash, and that during the same time, B is in need of at least that much money for a period of time (e.g., two weeks) that is fully contained within the remainder of the 120-day period of the debt.

Under these conditions, A can loan the $100,000 to B at a controlled risk because that loan can be secured by B's receivable from A. According to a method of the invention, a second debt is created between A and B, in an amount of $100,000 for a period of 14 days (i.e., X′=$100,000 and t′=14 days). Suppose, in this example, that the loan carries an interest that amounts to $i, and that, in the event B fails to return the loan, A would suffer additional expenses to the amount of $e. A and B would agree to secure the loan by temporarily reducing the basic debt of A to B by $100K+$i+$e. If, following the two week period, B returns the loan and the loan interest, then the basic debt returns to its initial state—$1,000,000 with a 120 day term. If, on the other hand, B, then A retains a reduced debt of $1M−$100K−$i−$e, and returns this sum within the 120 day period.

Since the risk of A in loaning to B is secured against its basic debt to B, the risk of the loan is managed. The direct value of the loan can be computed, for example, by reducing the alternative risk-free gain of A from the alternative cost of B. The former is the interest on short term government bonds. The latter is the interest rate offered to B in its line of credit. This value is divided between the lender and the borrower, with possibly a commission paid to a party that organized of the deal (e.g., the party(ies) that operates the system of FIG. 1 and/or the methods of FIGS. 3A and/or 3B). Because of this managed risk, the interest rate of such business to business loans can be lower than the prevailing Prime rate.

FIG. 4B illustrates a second scenario of finalizing a loan between businesses. Business A owes a debt to business B (X, t), which owes a debt to business C (Y, t″). It may be the case that while A is in a debt of $1,000,000 for 120 days to B, and A has surplus cash, B does not need a loan at that time. However, it may well be that B is in debt of $500,000 for 90 days to business C, and that C does need cash. In this scenario, A can loan C a sum of less than or equal to Min{$X, $Y} (i.e., the smaller amount of A's debt to B and B's debt to C) for any period shorter than Min{t, t′} (i.e., the smaller remaining period of A's debt to B and B's debt to C). In the case of this example, any loan of up to $500,000 and for a period of up to 90 days is possible. The loan from A to C is, in some implementations, executed as two separate loans—from A to B, secured by the debt of A to B and from B to C secured by the debt of B to C.

If C fails to return the loan within the specified time, then either B would still repay A, and deduct all the damage from its debt to C, or B will also not repay A. In this latter case both A will deduct all damages from its debt to B and B will deduct its own damages, including those resulting from A's deduction, from its debt to C. If, during the loan period B becomes illiquid (e.g., goes bankrupt) then C pays the debt directly to A. Even in this case, after the payment by C to A of X′ is made, both A and C recover the same debt structure they had prior to the loan. If both B and C fail to complete the deal and return the payment of X′, then A deducts the loan, interest and damage from its debt to B; B deducts this sum from its debt to C; and C retains the cash.

Although multi-party loans can be extended through a chain of any number of parties, the direct value of the loan (i.e., the lending and receiving of cash), is only generated by the initial lender and the final borrower. As the other parties in the chain are compensated in some implementations (e.g., through interest payments or commissions), the value to each party may diminish with the growth of the number of parties. Thus, in some implementations, it is desirable to extend the loan through as short a chain as possible.

FIG. 4C illustrates a variation of FIG. 4A, wherein a mediator M mediates the loan from B to A. Returning to the scenario of FIG. 4A where company A has a basic debt of (X, t) to company B, and A wishes to loan a sum X′ to B for a period t′ in return for an interest payment of $i, such loans can be mediated by a third party M. In this implementation, A, B and M agree to the following terms:

1. A transfers $X′ cash to B.

2. B forgives $X′+$i of the basic debt of A.

3. A commits to pay $X′+$i to M in t days.

4. M commits to pay $X′+$i to A in t′ days.

5. M commits to pay $X′+$i to B in t days.

6. B commits to pay $X′+$i to M in t′ days.

Agreement may be made, for example, by signing (on paper or electronically) a contract consistent with these terms or utilizing an electronic agent (discussed below).

Unlike the basic debt of (X, t), the commitments in 3 through 6 are conditional. Commitments 4 and 6 are purged in the event that the borrower B pays $X′ plus the interest to the lender A within time t′, and the original debt (X, t) is raised back to its original value. Commitments 3 and 5 are purged in case B does not pay the sum X′ within time t′.

The structure of the risk in mediated two-party risk-free loans is slightly different than that in its direct equivalent (e.g., of FIG. 4A). However, the loan still poses managed risk to the principal or interest of the loan (X, t). Thus, if the borrower B defaults, the lender A is paid back by the mediator M. If both the borrower B and the mediator M default, then the lender A reduces its basic debt (X, t) to the borrower by an amount X′. A risk to the mediator is if the borrower B defaults first, and after the lender A is paid, it defaults as well. However, the mediator M can manage this risk, for example, by way of its commission or from the interest for its service. Mediators may be desirable in some implementations because it allows outsourcing of administrative aspects of the loan process.

FIG. 4D illustrates a variation of FIG. 4B, wherein a mediator M mediates the loan from C to A, by way of B. A owes a debt to B (X,t), which owes a debt to C (Y, t″). In mediated multi-party loans there are four different parties—the lender, the borrower, the mediator, and one or more intermediaries who are in a chain of debt between the lender (e.g., C) and borrower (e.g., A). The deals signed between the lender and mediator and the borrower and mediator are similar to those described in connection with the two-way mediated loan of FIG. 4C. In this implementation, A, B, C and M agree to the following terms:

1. A transfers $X′ cash to C.

2. B forgives $X′+$i of the basic debt of A.

3. C forgives $X′+$i of the basic debt of B.

4. A commits to pay $X′+$i to M in t days.

5. M commits to pay $X′+$i to A in t′ days.

6. M commits to pay $X′+$i to B in t days.

7. B commits to pay $X′+$i to M in t″ days.

8. C commits to pay $X′+$i to M in t′ days.

9. M commits to pay $X′+$i to C in t″ days.

Agreement may be made by, for example, signing (on paper or electronically) a contract consistent with these terms or utilizing an electronic agent (discussed below).

The lender A transfers cash to the borrower C in return for a short term debt (X′, t′) from the mediator M conditioned on the failure of the borrower C to return the money (X′). The lender A commits to pay the mediator M part of its debt (X′) to the intermediary B conditioned on the repayment by the mediator M of the loan (X′, t), and the intermediary B forgives that sum. The borrower C receives the cash in return for a short-term debt to the mediator M of (X′, t). It also forgives part of its receivables from the intermediary B in return for a matching debt (X′, t″) from the mediator M. In short, had there been no intermediaries, a mediated multi-party loan would revert to its two party equivalent.

The deal with each of the intermediaries is simpler. Each one agrees to transfer some of its receivable debt to the mediator in return for the mediator assuming some of its payable debt. This incurs a managed risk to the facilitator. At most, if the mediator fails to pay its debt, the intermediary can avoid paying its own matching debt.

FIG. 4E illustrates the case of FIG. 4D in which business entity C defaults in paying back amount X′ within time t′. From B's perspective, the mediator pays A back the amount X′ and the debt from the mediator to B is purged. However, the mediator retains a debt from B for the amount X′. Thus, when B's debt to C comes due, the mediator is entitled to receive X′ of that debt.

FIG. 4F illustrates the case of FIG. 4D in which business entity C defaults in paying back amount X′ within time t′. From A's perspective, the mediator pays A back the amount X′ and the debt from the mediator to A is purged. However, the mediator retains a debt from A for the amount X′. Thus, when A's debt to B comes due, the mediator is entitled to receive X′ of that debt.

Intermediaries need not concern themselves with the identity of the lender, the borrower, or the other intermediaries (except for the former and next ones in line). Thus, authorization of loans can be simplified. Also, it is possible to disconnect the compensation of intermediaries from the actual deals in which they take part. The mediator can, for example, compensate an intermediary by providing insurance for its debt to the intermediary, thereby limiting the exposure of the intermediary to the previous intermediary in the chain. Another way in which an intermediary can be compensated is by allowing it to participate as part lender or part borrower in the deal (e.g., the intermediary B allows the securing of a loan from a lender A to a borrower C if, as part of the deal, B becomes a borrower from A in a two-party loan).

Nullifying Debt Between Businesses

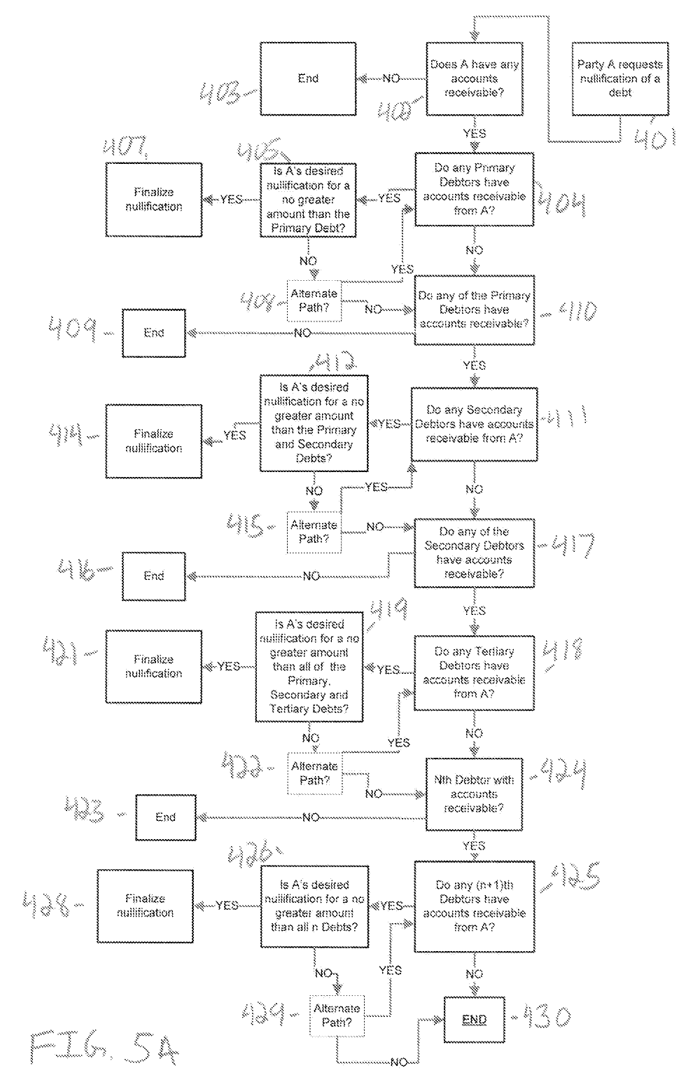

FIG. 5A illustrates an implementation of a method for facilitating the nullification (in whole or in part) of debt between one business and another. This illustration is from the perspective of a party who has a debt it wishes to nullify (401). For example, a party may seek to nullify all possible debts. This method is equally applicable for identifying nullification routes, which may be helpful, for example, for choosing a vendor who can be paid (in whole or in part) with offsetting debt rather than cash. All of these methods can be implemented, for example, by the system 100 of FIG. 1. The party can choose a particular debt that it wants to nullify; such a method is described below in connection with FIG. 5B.

It is determined whether the party who desires a to nullify a debt, (e.g., business A), has any accounts receivable (402). Since accounts receivable are the basis for nullifying debts in this implementation, if business A has no accounts receivable from which to nullify (or subtract) a debt(s), the process ends (403). If, however, business A does have accounts receivable, it is determined whether any of the primary debtors (e.g., tier 203 of FIG. 2, who are all A's debtors) have accounts receivable from business A. In other words, block 404 determines if any of the primary debtors are also business A's creditors.

Note that the amount of the accounts receivable from business A is relevant because it limits the amount of debt that can be nullified. An accounts receivable from A having an amount less than the requested nullification does not necessarily preclude nullification in some implementations, but rather limits the amount of nullification. In such a case, the nullification can be the least of the accounts receivable from A or the debts in the chain to A.

If a primary debtor does have accounts receivable from A, it is determined (405) whether business A's requested nullification is for a debt in an amount no greater than the primary debt (e.g., item 202 of FIG. 2). If A's requested nullification meets this requirement, the next block is to finalize the nullification (407). Several debtors may be able to provide the nullification. For example, it may be that debtors B1 and B2 of FIG. 2 have accounts receivable from A, and could provide a suitable nullification given the result of block 405. Block 405 is capable of being iterated so as to identify all possible routes of nullification of those primary debtors identified in block 404. As such, block 407 can include the process of presenting business A with options vis-à-vis potential routes of nullification (e.g., presenting the identity of the businesses that can provide an offsetting debt for nullification), along with certain data that may assist in making a decision (e.g., the interest rates and terms of the relevant accounts payable and receivable). Moreover, it is not necessary that the process end at block 407. After identifying possible nullification routes at block 406, the process can continue onto block 410 in an attempt to identify nullification routes in other tiers (e.g., items 205, 207, 209 and/or 211 of FIG. 2).

If the requested nullification does not meet the requirements in block 405, it is determined whether an alternate path is available (407). For example, it may be that debtor B2 of FIG. 2 has accounts receivable from A, but the debt owed by B2 to A is too small in size to cover the requested nullification. In the case of FIG. 2, the method would return to block 404 and analyze debtors B3 and B4. The alternate path block 408 does not, in most implementations, cause block 404 to re-analyze a debtor already analyzed. If there are no alternate paths available (e.g., the last available primary debtor with accounts receivable from A does not owe a to debt A that can cover the requested nullification), the process moves onto to block 410 to possible identify a potential nullification route in a subsequent tier.

If, at block 410, it is determined that none of the primary debtors has an accounts receivable, the process ends (409). As no primary debtors have accounts receivable from business A, and there are no debts owed to any primary debtors, there exists no chain of debts and credit to business A that can provide a nullification route. When the process reaches an “end” block (e.g., 409, 416, 423, or 430) it does not necessarily mean that no nullification route has been identified, but simply that the process has arrived at the end of available options.

In some implementations, (e.g., to avoid not being able to nullify any debt for business A) a variation on the alternate path block 408 is available. If the debt owed by primary debtor to A is too small in size to cover the requested nullification, the method can nullify part of the debt. The method can assemble these partial nullifications together to satisfy some or all of business A's request.

If some of the primary debtors have accounts receivable, it is determined (411) whether any of the secondary debtors (e.g., tier 205 of FIG. 2, who are B1-B4's debtors) have accounts receivable from A.

If a secondary debtor does have accounts receivable from A, it is determined (412) whether A's requested nullification is for an amount no greater than the primary debt owed to business A (e.g., from B1 to A of FIG. 2) and the secondary debt owed to the primary debtor (e.g., from C1 to B1 of FIG. 2). If A's requested nullification meets these requirements, the next block is to finalize the nullification (414). Several debtors may be able to provide the nullification. For example, it may be that debtors C1 and C2 of FIG. 2 could provide a suitable nullification given the result of block 412. Block 412 is capable of being iterated so as to identify all possible routes of nullification by way of those secondary debtors identified in block 411. As such, block 414 can include the process of presenting A with options vis-à-vis potential routes of nullification, along with certain data that may assist in making a decision. Moreover, it is not necessary that the process end at block 414. After identifying possible nullification routes at block 414, the process can continue onto block 417 in an attempt to identify nullification routes in other tiers (e.g., items 207, 209 and/or 211 of FIG. 2).

If the requested nullification does not meet the requirements of block 412, it is determined whether an alternate path is available (415). For example, it may be that debtor C2 of FIG. 2 has an accounts receivable from A, but the debt owed by B2 or C2 to A is too small in size to cover the requested nullification. In the case of FIG. 2, the method would return to block 411 and analyze debtors C3 (and B3) and C4 (and B4). Note that the alternate path block 415 does not, in most implementations, cause block 411 to re-analyze a debtor already analyzed. If there are no alternate paths available (e.g., the last available secondary debtor with accounts receivable from A does not owe a debt to A that can cover the requested nullification), the process proceeds to block 417 to search for a possible nullification route in a subsequent tier.

If, at block 417, it is determined that none of the secondary debtors has an accounts receivable, the process ends (416). As no additional primary or secondary debtors have accounts receivable, and no debts are owed to any secondary debtors, there exists no chain of debts and credit to business A that can provide a nullification route.

In some implementations (e.g., to avoid not being able to nullify debt for business A), a variation on the alternate path block 415 is available. If the debt owed by a primary debtor to business A or from the secondary debtor to the primary debtor is too small in size, the method can nullify part of the debt. The method can assemble these nullifications together to satisfy some or all of A's request.

The blocks associated with tertiary debtors, e.g., blocks 418-424 are analogous to the respective blocks associated with secondary debtors and, therefore, will not be discussed in detail.

The method can continue through any n tiers of debtors. If some of the nth debtors have accounts receivable (424), it is determined (425) whether any of the (n+1)th debtors (e.g., tier 211 of FIG. 2) have accounts receivable from A.

If an (n+1)th debtor does have accounts receivable from A, it is determined (426) whether A's requested nullification is for an amount no greater than the debts in the chain toward business A, i.e., all n debts (e.g, the debts that are owed from (n+1)1 to n1, from n1 through the chain to D1, from D1 to C1, from C1 to B1 and from B1 to A). If A's requested nullification meets these requirements, the next block is to finalize the nullification (427). Several debtors may be able to provide the nullification. For example, it may be that debtors (n+1)1 and (n+1)3 of FIG. 2 have accounts receivable from A and could provide a suitable nullification given the results of block 426. Block 426 is capable of being iterated so as to identify all possible nullification routes of those debtors identified in block 425. As such, block 428 can include the process of presenting A with options vis-à-vis potential nullification routes, along with certain data that may assist in making a decision.

If the requested nullification does not meet the requirements in block 426, it is determined whether an alternate path is available (429). For example, it may be that debtor (n+1)2 of FIG. 2 has accounts receivable from A, but the debt owed by B2, C2, D2 or n2 is too small in size to cover the requested nullification. In the case of FIG. 2, the method would return to block 425 and analyze debtors (n+1)3 (and n3, D3, C3 and B3) and (n+1)4 (and n4, D4, C4 and B4). The alternate path block 429 does not, in most implementations, cause block 425 to re-analyze a debtor already analyzed. If there are no alternate paths available, the process ends at block 429. If, at block 425, it is determined that none of the (n+1)th debtors has accounts receivable from A, the process ends (430).

FIG. 5B illustrates an implementation of a method for nullifying a particular debt specified by a party. In this illustration, A requests nullification of a debt to C (501). It is first determined whether A has any accounts receivable. If it does not, the process ends (503) because there exists nothing to offset the debt. If A does have accounts receivable, C's creditors are identified (504). It is then determined (505) whether there is a chain of debt from C's creditors to A. If there is no such chain (506), the process ends (507). If there is such a chain (508), it is determined whether all debts in the chain at least as large as the amount of the debt from A to C (509). If there is a fault in the chain (e.g., the debt from one creditor to the next is too small to cover the requested nullification), the method returns to block 505 to identify a different chain. This loop continues until either a usable chain is identified, or it is determined that no chain exists (506) and the process ends (507). If a usable chain is identified, the nullification is finalized (510).

Depending on the implementation, the determinations at blocks 402, 404-405, 407, 408, 410-412, 414, 415, 417-419, 421, 422, 424-426, 428, 429, 502, 504-506 and 508-510 (and others like it) can be made, for example, by, a matching server (items 117 or 118 of FIG. 1) interfacing with a business server (items 104, 105 and/or 107 of FIG. 1) associated with a debtor to analyze its accounting data.

Examples of Finalizing a Nullification Between Businesses

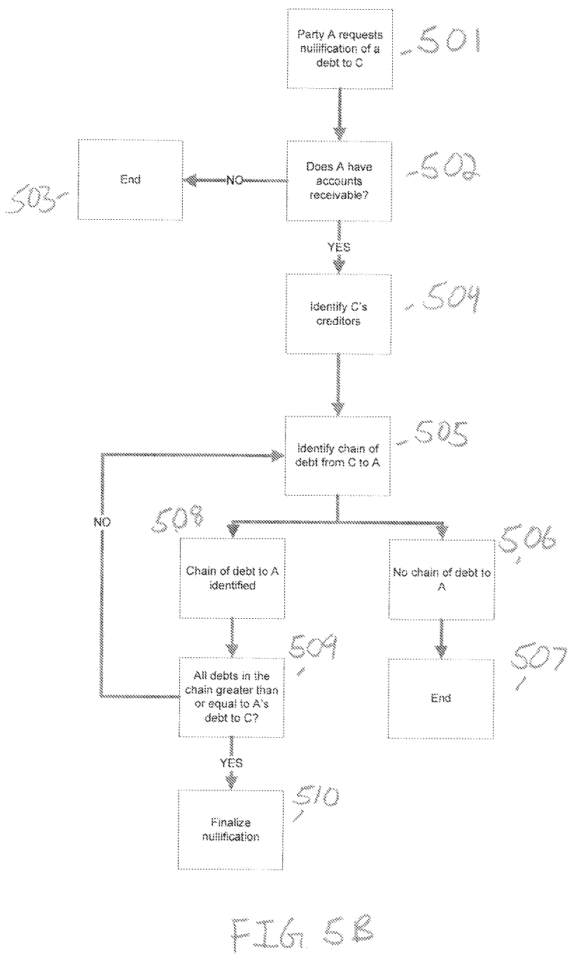

FIG. 6A illustrates a structure of debt between A, B2 and C2. In this example, A requested nullification of a debt (X, t). A could have requested nullification of the specific debt to C2, or it could have more generally requested nullification of a debt in the amount X. In this example, it is assumed that the method of FIG. 5A (and implemented, e.g., by the system of FIG. 1) identified B2 as having no accounts receivable from A, and identified C2 as having an account receivable from A. For purposes of this illustration, the following values are assumed:

| | |
|---|---|
| X, t | $1000, 15 Days |
| Y, t′ | $1000, 30 Days |
| Z, t″ | $1500, 30 Days |

Because the debt A seeks to nullify is for an amount less than the primary and secondary debts, it can be completely nullified. As a result, after nullification (or subtraction) of (X, t), the debt structure of the parties changes as follows:

| | |
|---|---|
| X, t | Nullified |
| Y, t′ | Nullified |
| Z, t″ | $500, 30 Days |

Each party's net balance remains the same as before nullification, i.e., A has a $0 net balance, B2 is owed $500 and C2 owes $500.

In this case, A has nullified a debt with a 15 day term and a receivable with a 30 day term. Therefore, A registers a loss of the interest on $1000 for the period of fifteen days. If, on the other hand, A had nullified a debt with a 30 day term and a receivable with a 15 day term, A would have earned the costs of providing $1000 during this period, either from deposits it may have or from a line-of-credit. Implementations can account for lost interest by either party by adjusting the value of the nullification. Either way, in most implementations, the interest gap between bank deposits and loans makes it probable that the direct gain from nullifying $1000 would outbalance the direct loss.

FIG. 6B illustrates an example of structure of debt between A and several other businesses. In this structure, there are two chains of debt, chain 2 and chain 3. Dotted lines represent debts on chain 2, and solid lines represent debts on chain 3.

Starting with the simpler case of the debts on chain 3, for purposes of this illustration, the following debt values are assumed:

| | |
|---|---|
| Q, t8 | $1000, 15 Days |
| R, t9 | $1500, 15 Days |
| S, t10 | $1000, 20 Days |
| T, t11 | $6000, 15 Days |

The debts on chain 3 represent the case where a party's primary debtor is also the party's creditor. In such a case, the method of FIG. 5A may be able to completely satisfy a nullification request by block 407. In this example, business J3 may have requested either that its debts to E3 and F3 be nullified, or it may have simply requested that $1000 of its debt be nullified. In the latter case, the method of FIG. 5A would present J3 with the option of nullifying the debts owed to E3 and/or F3. J3 may receive notice of its options in various fashions, including, for example, an email alert or a prompt in its accounting software (see, e.g., items 108 and 109 of FIG. 1). Both of these debts can be nullified because the amounts of the debts owed by J3 to E3 and F3 are less than the amounts of the debts owed by E3 and F3 to J3, respectively. Presuming that J3 decides to nullify its debts with both E3 and F3, after nullification, the debt structure would become:

| | |
|---|---|
| Q, t8 | Nullified |
| R, t9 | $500, 15 Days |
| S, t10 | Nullified |
| T, t11 | $5000, 15 Days |

Each party's net balance remains the same as before nullification (i.e., E3 owes $500, J3 is owed $5500 and F3 owes $5000).

Turning to the debts on chain 2, for purposes of illustration, the following values are assumed:

| | |
|---|---|
| X, t | $500, 30 Days |
| Y, t2 | $2000, 15 Days |
| Z, t3 | $1000, 30 Days |
| M, t4 | $750, 30 Days |
| N, t5 | $2500, 30 Days |
| O, t6 | $1000, 45 Days |
| P, t7 | $3000, 15 Days |

In this case, the method of FIG. 5A would have to proceed to the sixth tier of debtors until it found a debtor with an accounts receivable from A. Alternatively, A may have specifically requested that the debt (X, t) be nullified.

The debt (X, t) is subtracted from all of the debts in chain 2. As a result, the debt structure would become:

| | |
|---|---|
| X, t | Nullified |
| Y, t2 | $1500, 15 Days |
| Z, t3 | $500, 30 Days |
| M, t4 | $250, 30 Days |
| N, t5 | $2000, 30 Days |
| O, t6 | $500, 45 Days |
| P, t7 | $2500, 15 Days |

Each party's net balance remains the same as before nullification (i.e., A is owed $1500, B2 owes $1000, C2 owes $250, D2 is owed $1750, I2 owes $1500, H2 is owed $2000 and G2 owes $2500).

System Configuration

The following paragraphs provide additional details of an example of a system to implement the methods of FIGS. 3A, 3B, 4A-4D, 5A, 5B, 6A and 6B.

As shown in FIG. 1, the elements associated with the first business are the business processor 101, accounting software 102 and plug-in 103. The elements associated with the second through nth businesses (i.e., items 104-109) are functionally similar, and therefore, will not be addressed separately. The business processor 101 can take many forms, but typically includes a computer, server and/or network of computers and servers. More specifically, the business processor 101 can be part of the business's Enterprise Resource Planning (“ERP”) system, which integrates some or all data and processes of a business into a unified system. An ERP system can use multiple components of computer software and hardware to achieve the integration. Some ERP systems use a unified database to store data for the various system modules and software components. In other implementations processor 101 can be a financial management software system.

The accounting software 102 is a software component that the business processor 101 executes. The accounting software 102 is associated with, among other things, a data store relating to the business's accounts payable and accounts receivable. In some implementations, the accounting software 102 is automatically updated, for example by point-of-sale or inventory modules coupled to the business processor 101. The accounting software 102 can include software packages made by SAP® AG of Walldorf, Germany.

A plug-in 103 interfaces with the business processor 101 and accounting software 102 and thereby enables transmission of certain accounts receivable data, accounts payable data, and preferences data to the matching servers (e.g., 117 and/or 118) for processing. Moreover, the plug-in 103 enables modification of the accounts receivable data and accounts payable data in the accounting software 102 based on the processing done by the matching servers (e.g., 117 and/or 118). For example, if the matching server 117, upon request, creates a loan or nullifies a debt from business A (associated with business processor 1, 101) to business B (associated with business processor 2, 104), the matching server 117 communicates via the network hub 110 with both business processors 101 and 104. The plug-in 103 allows the matching server 117 to edit accounts receivable and payable data in the accounting software 102 to reflect that business A has extended a loan to business B or that a debt has been nullified. Thus, if A has extended a $1500.00 loan to B, the plug-in 103, based on communication with matching server 117, alters A's accounting data in the accounting software 102 as follows (if B fails to return the loan is the account payable is reduced to $500, and the receivable is purged):

| | BEFORE LOAN | AFTER LOAN |
|---|---|---|
| | FROM A TO B | FROM A TO B |
| Accounts Payable | $2000 | $2000 |
| (to B) | | |
| Accounts Receivable | $0 | $1500 |
| (from B) | | |

The plug-in 106, based on communication with matching server 117, alters B's accounting data in the accounting software 105 as follows (if B does not return the loan, the accounts receivable is reduced to $500):

| | BEFORE LOAN | AFTER LOAN |
|---|---|---|
| | FROM A TO B | FROM A TO B |
| Accounts Payable | $0 | $1500 |
| (to A) | | |
| Accounts Receivable | $2000 | $2000 |
| (from A) | | |

In a case where a debt of $1500.00 from A to B is nullified by a matching debt from B to A, the plug-in 103, based on communication with matching server 117, alters A's accounting data in the accounting software 102 as follows:

| | BEFORE | AFTER |
|---|---|---|
| | NULLIFICATION | NULLIFICATION |
| Accounts Payable | $1500 | $0 |
| (to B) | | |
| Accounts Receivable | $2000 | $2000 |
| (from B) | | |

The plug-in 106, based on communication with matching server 117, alters B's accounting data in the accounting software 105 as follows:

| | BEFORE | AFTER |
|---|---|---|
| | NULLIFICATION | NULLIFICATION |
| Accounts Payable | $2000 | $500 |
| (to A) | | |
| Accounts Receivable | $1500 | $1500 |
| (from A) | | |

Moreover, additional data regarding the loan or nullification can include the period (i.e., the time within which the loan must be repaid), the amount, the interest rate, and information concerning the debtor (e.g., contact information, credit information, order history, other payables/receivables).

The plug-in 106 allows the matching server 117 to edit accounts receivable and payable data in the accounting software 105 to reflect the loan from business B. The data regarding the loan can include the period (i.e., the time within which the loan must be repaid), the amount, the interest rate, and information concerning the creditor (e.g., contact information, credit information, order history, other payables/receivables). The plug-in (e.g., 103, 106 or 109) also can contain configuration data such as limitations on the amount the business wishes to lend to any other business, maximum amount of credit that can be extended in total, maximum number of simultaneous loans (e.g., as debtor and/or creditor), whether loan amounts should be limited to the value of unpaid-for merchandise from the debtor, whether the business does not desire to extend, receive or nullify credit from certain business or types of businesses (e.g., the plug can contain an exclusion list of businesses or types of businesses), the maximum interest income that can be lost as a result of a nullification (e.g., in the case of nullifying a longer term accounts receivable for a shorter term accounts payable) and whether the processes should identify nullifications that could save the most amount in interest payments (e.g., preferentially attempt to offset longer term accounts payable with shorter term accounts receivable). This configuration data can affect how and whether loans or nullifications occur between businesses.

Interest rate calculations, e.g., for the purpose of preferentially choosing or identifying nullifications that would reduce interest cost or increase interest income, can operate by identifying the amount, interest rate and remaining period associated with the debt(s) in question. For example, if B owes a $10,000 debt that to A which has a remaining period of 100 days and has a 12.5% A.P.R., the remaining future interest income to A is about $342. If A owes $10,000 to B, and the debt has 45 days remaining and has a 9.5% A.P.R., the remaining future interest cost to A is about $117. In this case, if A chooses to nullify these debts, A stands to lose about $225 in interest income. Thus, this type of nullification may not be desirable for A, but may be the type that is identified for B as a means of reducing interest cost. Despite the loss of interest income, business A may have other reasons that make such a nullification desirable (e.g., reduction of credit exposure).

Matching servers 117 and 118 generally take the form of one or more computers (networked or independent) with specialized software. Each server has communication abilities to enable interfacing with other classes (e.g., business or mediators) via the network/hub 110. Servers may communicate with other servers either via the network/hub 110 or via a separate communication link. For example, servers 117 and 118 may have a proprietary link for load balancing or performance optimization. Each matching server, up to “n” matching servers, has functionally similar elements, so the explanation will focus on matching server 1, i.e., item 117.

The specialized software in the matching servers (e.g., 117 and 118) allows them to analyze the accounts payable and accounts receivable data for each business (e.g., that which is stored in or associated with accounting software 102, 105 and 108) to identify another business, or a series of businesses, that can satisfy a credit request. For example, an implementation may operate within a the network of businesses which relate to each other as suppliers and customers. In many companies, accounting data is available in electronic form. It thus can be automatically read and processed by the matching server 117. Once the data is read and combined with the data from other companies, the list of possible deals can be generated. Given a demand for credit, the server 117 traverses this network looking for reported available cash and a chain of debt. For a nullification, the server 117 traverses the network looking for an offsetting receivable and chain of debt. This search may be limited by restrictions or preferences that businesses choose to impose on the credit they extend or accept. A further consideration, in some implementations, is to minimize the path from credit giver to a credit seeker so that, for example, the value (such as interest charges, commissions, etc.) has to be shared by fewer parties. Still other considerations, in some implications, include minimizing interest lost be nullification (e.g., by searching to avoid nullifying a longer term accounts receivable for a shorter term accounts payable) and searching to preferentially identify nullifications that could save the most amount in interest payments (e.g., by preferentially attempting to offset longer term accounts payable with shorter term accounts receivable).

The elements associated with the first mediator are the mediator processor 111, mediator accounting software 112 and mediator plug-in 113. The elements associated with all “n” mediators (i.e., items 114-116) are functionally similar, and therefore, will not be addressed separately. The mediator accounting software 112 and mediator plug-in 113 differ from that employed by the business entities (e.g., account software 102 and plug-in 103) in that the mediator's personal accounts receivable and accounts payable data are not polled for matching debts or credits or available cash. Rather than actually extending or receiving a loan, the mediator assists two or more businesses in extending a loan from one to the other. In that role, the mediator may create debts and credits between itself and the parties as a means of securing the loan. These debts and credits can be entered automatically into the mediator accounting software 112 by way of the mediator plug-in 113. In some implementations, the mediator receives a commission for its services. The commission may be a flat fee or a percentage of the loan amount.

### EXAMPLES

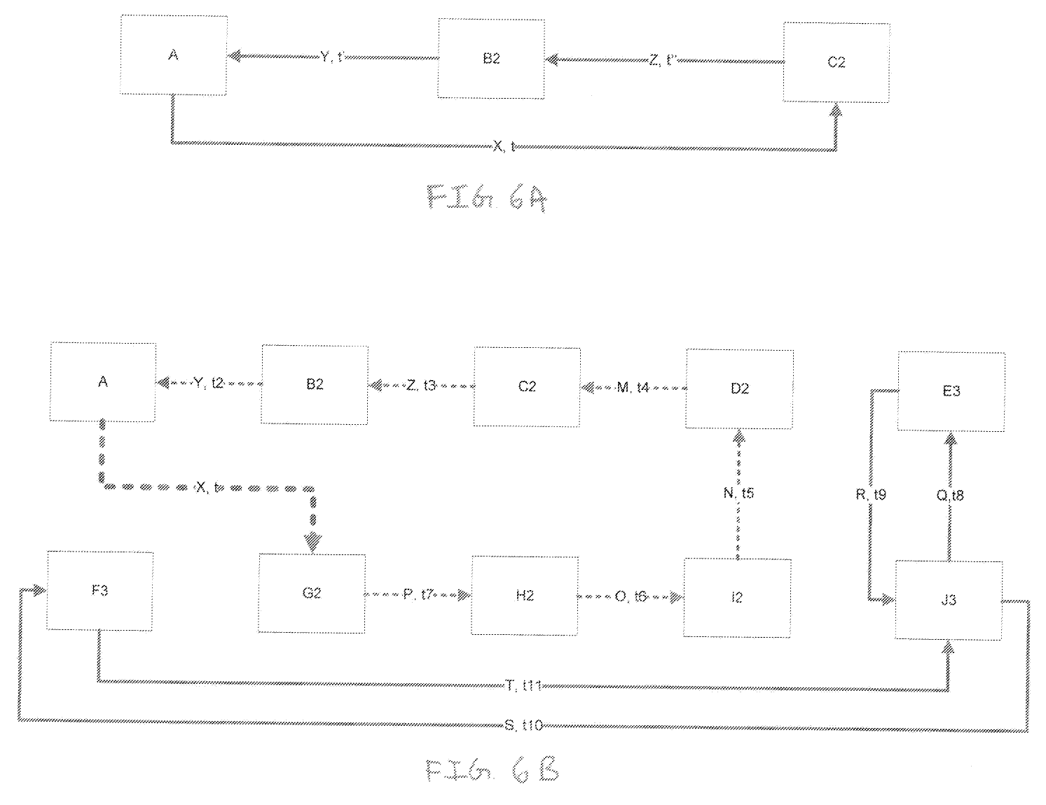

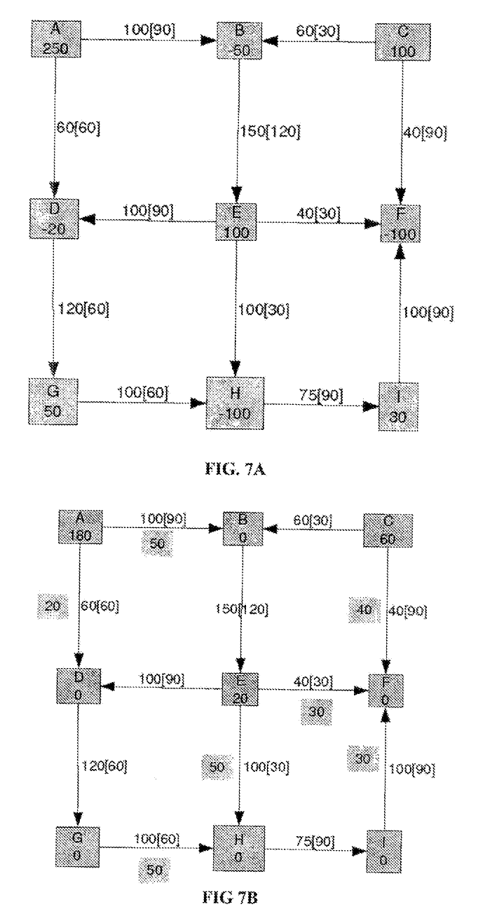

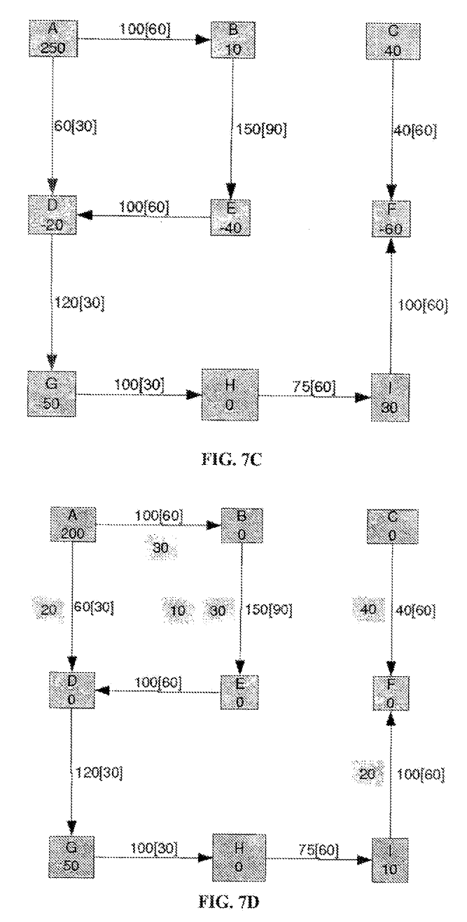

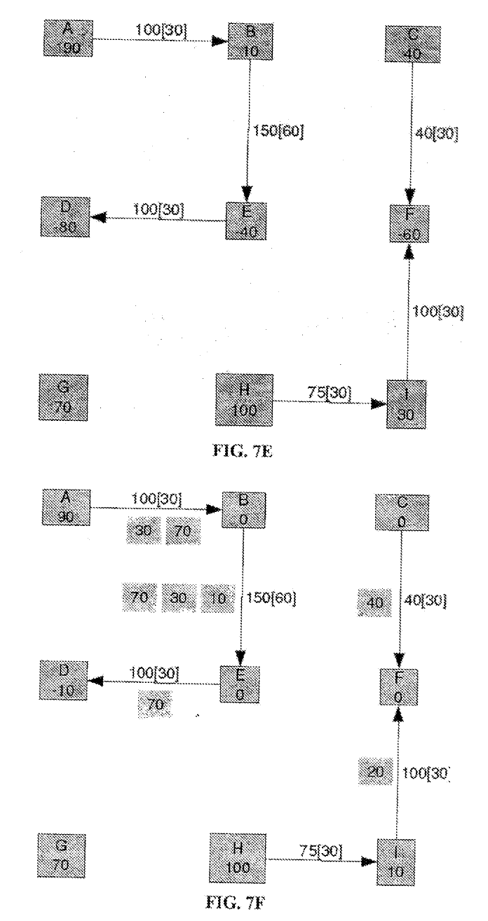

FIG. 7A illustrates a network of debtors and creditors A through I. The initial cash balance of each business is given inside its box, in thousands. For example, A has an initial cash balance of $250,000 and B has an initial cash balance of ($50,000). The arrows are marked X[Y], which indicates a debt of sum X due in Y days. As before, the debtor is at the tail of the arrow, and the creditor is at the arrowhead.

FIG. 7B illustrates the same network of debtors and creditors as shown in FIG. 7A. Here, however, the businesses have extended some loans to each other, the amounts of which are indicated in a box alongside an arrow. For example, A has extended a loan of $20,000 to D and $50,000 to B. As a result, B no longer has a negative cash balance. The cash needs of the businesses in this illustration are met by direct loans from other businesses. The cash balances of some of the companies are as follows (the calculation of these balances can be accomplished, e.g., by the system of FIG. 1):

| Balance A | Balance B | Balance D | Balance E |
|---|---|---|---|
| Initial: $250,000 | Initial: ($50,000) | Initial: ($20,000) | Initial: $100,000 |
| To B: ($50,000) | From A: $50,000 | From A: $20,000 | To F: ($30,000) |
| To D: ($20,000) | | | To H: ($50,000) |
| TOTAL: $180,000 | TOTAL: 0 | TOTAL: 0 | TOTAL: $20,000 |

These loans are mediated by a party M, who as a result, collects a fee or commission. In this implementation, the revenue for the loans shown in FIG. 7B is $675, which is 1/12 of 3%, i.e., one month's share of the annual percentage rate (“APR”), multiplied by the total amount of loans outstanding. To extract a commission, the organization providing the system preferably is able to track every transaction carried using the system. One way to accomplish that is to require that all loans to be mediated, and to serve as the mediator. In this implementation, the function of the mediator in a successful deal is strictly one of accounting—it is specifically not involved in any cash transfer. Still, the mediator has complete knowledge of the deals and is able to require payment for them.

With short-term credit, the yield of individual transactions is small, and substantial value can arrive from managing multiple transactions on a daily basis. It is thus preferable, in most implementations, to reduce the administrative cost of every transaction. Specifically, the costs of structuring a deal (in terms of partners), negotiating financial terms (sums, periods, interest rate, and securities), and executing the deal preferably are minimized.

FIG. 7C illustrates the same network of debtors and creditors as FIG. 7B, but thirty days later. As shown, some debt has come due and been paid (e.g., the loan from C to B, the loan from E to F, and the loan from E to H). The cash balances of some of the companies are now as follows:

| Balance A | Balance B | Balance D | Balance E |
|---|---|---|---|
| Initial: $250,000 | Initial: ($50,000) | Initial: ($20,000) | Initial: $100,000 |
| | From C: $60,000 | | To F: ($40,000) |
| | | | To H: ($100,000) |
| TOTAL: $250,000 | TOTAL: $10,000 | TOTAL: ($20,000) | TOTAL: ($40,000) |

FIG. 7D illustrates the same network of debtors and creditors as FIG. 7C, but with some new loans between businesses mediated by M. As in FIG. 7B, all of the cash needs of the businesses are met by business to business loans. For example, in this case B has borrowed $30,000 from A in order to lend $40,000 to E. In this scenario, the total revenue for the mediator M is $300. The cash balances of some of the companies are now as follows:

| Balance A | Balance B | Balance D | Balance E |
|---|---|---|---|
| Initial: $250,000 | Initial: ($50,000) | Initial: ($20,000) | Initial: $100,000 |
| To B: ($30,000) | From C: $60,000 | From A: $20,000 | To F: ($40,000) |
| To D: ($20,000) | From A: $30,000 | | To H: ($100,000) |
| | To E: ($40,000) | | From B: $40,000 |
| TOTAL: $200,000 | TOTAL: $0 | TOTAL: $0 | TOTAL: $0 |

FIG. 7E illustrates the same network of debtors and creditors as FIG. 7D, but 30 days as passed. As shown, some debt has come due and been paid (e.g., the loan from A to D, the loan from D to G and the loan from G to H). The cash balances of some of the companies are now as follows:

| Balance A | Balance B | Balance D | Balance E |
|---|---|---|---|
| Initial: $250,000 | Initial: ($50,000) | Initial: ($20,000) | Initial: $100,000 |
| To D: ($60,000) | From C: $60,000 | From A: $60,000 | To F: ($40,000) |
| | | To G: ($120,000) | To H: ($100,000) |
| TOTAL: $190,000 | TOTAL: $0 | TOTAL: ($80,000) | TOTAL: ($40,000) |

FIG. 7F illustrates the same network of debtors and creditors as FIG. 7E, but with some new loans between businesses mediated by M. B has borrowed as much as possible from A, B has loaned E its own funds along with some the money borrowed from A, and E lends D some of the borrowed money, but not enough to cover all of D's needs. In this scenario, the total revenue for the mediator M is $425. The cash balances of some of the companies are now as follows:

| Balance A | Balance B | Balance D | Balance E |
|---|---|---|---|
| Initial: $250,000 | Initial: ($50,000) | Initial: ($20,000) | Initial: $100,000 |
| To D: ($60,000) | From C: $60,000 | From A: $60,000 | To F: ($40,000) |
| To B: ($100,000) | From A: $100,000 | To G: ($120,000) | To H: ($100,000) |
| | To E: ($110,000) | From E: $70,000 | From B: $110,000 |
| | | | To D: ($70,000) |
| TOTAL: $90,000 | TOTAL: $0 | TOTAL: ($10,000) | TOTAL: $0 |

Some Characteristics and Advantages of Business to Business Banking

In some implementations, a system and method for business to business banking is provided that facilitates and/or simplifies credit relations between businesses.

As discussed, cash flow management is one of the daily activities that many businesses perform. Part of that activity is making sure that income is sufficient to cover expenses. If it is, the remaining sum is generally invested until it is needed. Commonly, short term bank deposits are used for this purpose. They carry a minimal interest rate and allow substantial flexibility. Another option is to pay advances to suppliers against reductions in the price of the merchandise or service they have provided or are expected to provide in the near future. In implementing this option, there are difficulties, including: First, the supplier has to have a need for the money, and the customer usually has no way of knowing that. Second, such advancement mechanism should be pre-negotiated, because the managerial overhead required for negotiating it separately in every occurrence usually cannot be justified by the gain. Some implementations of the disclosed systems and methods can address these difficulties.

Almost equally as often as a business faces surplus income, it may face excess expenses. When a business is short of cash on a given day, it has several options. One option is to withdraw from deposits it may have in the bank. However, since these deposits carry marginal income, many businesses strive not to hold too much cash in deposits. A second option is to take a short term loan from the bank, e.g., by drawing from an existing line of credit. As discussed, the interest on such loans is typically several percent higher than what is paid on deposits. Another option the business has is to request an advance from its customers. Like offering advancements, implementing this option has difficulties, including: First, the customer would need to have excess cash to loan, and the supplier usually has no way of knowing that. Second, such advancement mechanism should be pre-negotiated, because the managerial overhead required for negotiating it separately in every occurrence usually cannot be justified by the gain. Some implementations of the disclosed systems and methods can address these difficulties.

Another activity that is often part of cash flow management is the optimization or management of receivables and payables. Generally speaking, it is preferred in some businesses to nullify an accounts receivable it has rather than gather the liquidity (e.g., by withdrawing funds, getting a short-term loan, etc.) needed to meet an accounts payable. This may be desired, for example, because of the cost of acquiring liquidity, the comparative ease (e.g., from a bookkeeping, accounting, or administrative perspective) that a payable can be cancelled by a receivable, and/or the advantages of reducing total credit exposure. However, implementing this option has difficulties. First, the simplest case of directly offsetting receivables (e.g., a customer and supplier each owing each other money) is likely uncommon. Second, such nullification should be pre-negotiated, because the managerial overhead required for negotiating it separately in every occurrence usually cannot be justified by the gain. Some implementations of the disclosed systems and methods can address these difficulties.

A business thus far described, could offer advances to other business entities for much less than the cost of bank interest. Indeed, credit provided by businesses to other businesses (sometimes referred to as “B2B”) is quite different from, and often more advantageous than, the credit products provided by banks. This is for several reasons, including:

1. Businesses are often less restricted by law as to the terms in which they give each other credit. The main exceptions for this rule include monopolies and companies that are partially owned by one another. The situation is different with banks. As banks, by an large, loan money that does not belong to them (e.g., savings money), they are subject to strict oversight and regulation. Thus, businesses may be more potent and flexible credit givers than banks.

2. Many businesses have long standing relations, and shared interests with their suppliers and customers. A business X, for example, may be the sole supplier of a product which is a main ingredient of the product of its customer Y. Thus, many businesses have deep knowledge of their suppliers and customers, which a bank is less likely to share. Business thus may be more capable of estimating their partners' credibility.

3. In many business, the transactions made by customers and suppliers are much larger than those made by bank clients. Thus, the managerial overhead of the finance department of many businesses is marginal compared to that of a bank. Structurally, many businesses are, therefore, much more efficient in their financial activities than banks.

4. Loans from customers can be strategically beneficial in that they reduce the exposure of the borrower to the lender and, thus, permit further sales. For the lender, the loan is desirable because it enhances its ability to extract better credit terms on its basic loan, without jeopardizing the robustness of its supplier.

Confidentiality Concerns in Business to Business Banking

One possible challenge in implementing to business to business loans (as compared to bank loans) is maintaining bank-like security and confidentiality. When a customer places a deposit at a bank, or receives a loan, only the customer and the bank know. The bank may require the customer to reveal certain kinds of information (e.g., its annual or quarterly financial reports, its books) and disclose the identity of its clients and suppliers. Any information disclosed is then kept confidential and is not revealed to any party outside the bank.

The same level of confidentiality can be maintained in an implementation of a business to business financial transaction system. Guidelines for maintaining privacy for some implementations include the following:

1. The only data revealed to the participants in a prospective loan relates to each party's own part of the deal—from whom they receive and to whom they transfer money, and the respective terms of the loan (e.g., duration, securities and interest).

2. The mediator is informed of the value of the signed deals, and identity of the payers of commissions.

3. The mediator receives the signed deal data, for logging purposes. This data is encrypted with a deal-specific key which is not given to the mediator or any of the participants.

4. The decryption key is provided to a trustee who only reveals the key in case the loan defaults or, e.g., pursuant to a court order.

5. Confidentiality is only maintained for loans that do not default.

With respect to maintaining security within an implementation of the system of FIG. 1, Secure Multiparty Computation (“SMC”) can be utilized. A benefit of SMC is that it is general and can be applied to any function computable by a computer or digital circuit. Each company would maintain a computerized agent. The agent would have access to accounting data, usually via the ERP system. This data, together with configuration data, constitutes the input to the SMC. Each agent then would initiate a sequence of SMC computations, each in the participation of a larger quorum of agents (e.g., all of those agents in a chain of debt). The output of every such computation to any of the participants would be the list of deals available to it in the quorum—such that only its own part of the deal and a deal identifier is provided. Suggested deals are presented, and are executed pending authorization. Once all of the participants of a certain deal have given their authorization, the deal is executed: The agents negotiate a key from the trustee; they each perform the required transactions; they encrypt the report about their part of the deal and send the encrypted data to the mediator, together with the deal identifiers.

Negotiating Terms of the Loans and Nullifications

Negotiating terms of the loans and nullifications has the potential to consume much managerial effort. Standardization of a limited number of possible deals can greatly remove overheads and increase overall gain. For instance, deals can be suggested for a small selection of periods (e.g., day, week, month), at strictly defined interest rates (e.g., LIBOR), and at different levels of securitization (100%, 80%, etc.). For each company, it is expected that there would be several competing ways in which it can satisfy its credit needs. Thus, some negotiation may occur.

One way in which the managerial overhead could be reduced is by handing over negotiation to an automatic agent. This approach is already implemented in other financial markets (e.g., foreign currency and stocks) with considerable success. Automated agents, when given the authorization to sign deals, have the further advantage of being able to act quickly and at any time. Thus, agents may be able to reap the most profitable deals.

Since the authorization of a deal by all of the participating parties in essential before it can be carried out, a manager (or an assigned automatic agent) can permit the execution of several selections out of a great number of possible deals. The first deals that gain authorization from all of the parties stand a better chance of being executed, whereas those deals that are authorized later might be purged because necessary parties already have consumed their capacity.

Once a deal is authorized by all of the participating parties, it needs to be executed. The execution of a deal—both the act of lending and the returning of a loan—consists of a sequence of accounting orders, and a single financial transaction. With modem accounting software, all of these actions can be carried out automatically, with little or no further human intervention (except for the necessary oversight). This can be facilitated by programming an extension, or plug-in, to the accounting system, which is capable of feeding transactions into the system. In some implementations, this system may be semi-automatic or fully automated.

Various features of the system may be implemented in hardware, software, or a combination of hardware and software. For example, some features of the system may be implemented in computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

A number of implementations of the invention have been described. Nevertheless, it will be understood that various modifications may be made without departing from the spirit and scope of the invention. For example, the methods and system can be used for extending loans and/or nullifying debt. Participants can request loans or offer them, and the system and/or method can identify possible deals. Moreover, participants can request nullification of a particular debt or identify nullification routes to, e.g., assist in choosing vendors. Accordingly, other implementations are within the scope of the following claims.

What is claimed is:

1. A method for extending credit from a first business entity to a second business entity comprising:
identifying a debt owed by a first business entity to a second business entity in an amount X that is due to be repaid within a time T; and
providing a loan from the first business entity to the second business entity, wherein the loan is for an amount Y and is due to be repaid within a time t, wherein Y≦X and the time t is not later than the time T,
wherein the loan from the first business entity to the second business entity is secured by the debt owed by the first business entity to the second business entity.

2. The method of claim 1 wherein if the second business entity fails to repay the loan to the first business entity within time t, the amount that the first business entity owes to the second business entity is reduced by Y.

3. The method of claim 1 wherein interest is charged for the loan from the first business entity to the second business entity, the interest over time t is equal to i, wherein if the second business entity fails to repay the loan to the first business entity within time t, the amount (Y+i) is subtracted from the amount that the first business entity owes to the second business entity.

4. The method of claim 1 comprising collecting a fee from at least one of the first business entity and the second business entity for providing the loan, wherein at least part of the fee is paid to a third party.

5. The method of claim 1 including determining whether the first business entity has excess cash for lending, prior to identifying the debt and providing the loan.

6. The method of claim 1 including determining whether the second business entity has requested a loan, prior to identifying the debt and providing the loan.

7. The method of claim 1 including determining whether the first business entity has extended a predetermined maximum amount of credit, prior to providing the loan.

8. The method of claim 1 including determining whether the first business entity has extended a predetermined maximum number of loans, prior to providing the loan.

9. The method of claim 1 including determining whether the first business entity has extended a predetermined maximum amount of credit to the second business entity, prior to providing the loan.

10. The method of claim 1 including determining whether the first business entity has excluded the second business entity from receiving a loan from the first business entity, prior to providing the loan.

11. The method of claim 1 wherein providing the loan comprises modifying the respective accounts payable data and accounts receivable data associated with the first business entity and second business entity.

12. The method of claim 11 wherein modifying the respective data comprises interfacing with respective business processors associated with the first business entity and the second business entity.

13. The method of claim 1 wherein identifying the debt comprises analyzing the accounts payable data of the first business entity and the accounts receivable data of the second business entity.

14. The method of claim 13 wherein analyzing the respective data comprises interfacing with respective business processors associated with the first business entity and the second business entity.

15. A method for extending a loan to a business entity comprising:
identifying a set of business entities n, where n={1 . . . (N+1)} and N≧2, and wherein, for n=1 through n=N, each particular entity n owes a respective debt to entity (n+1), each respective debt being in a respective amount Xₙ that is due within a respective time Tₙ; and
for each entity n=1 through n=N, providing a loan in an amount Y from entity n to entity (n+1), each loan being due within a period of time t, wherein the amount Y is no greater than the smallest of the respective amounts Xₙ and wherein the time t is no later than the smallest of the respective times Tₙ.

16. The method of claim 15 wherein each respective loan from entity n to entity (n+1) is secured by the respective debt owed by entity n to entity (n+1).

17. The method of claim 15 wherein, if entity (n+1) fails to repay the loan to entity n within time t, the amount Y is subtracted from the amount that entity n owes to entity (n+1).

18. The method of claim 15, wherein interest is charged for the loan from entity n to entity (n+1) and the interest over time t is equal to i, wherein, if the entity (n+1) fails to repay the loan to entity n within time t, the amount (Y+i) is subtracted from the amount that entity n owes to entity (n+1).

19. The method of claim 15 comprising collecting a fee from at least one of the n entities for providing the loan, wherein at least some of the fee is paid to a party outside the set of business entities n.

20. A method for extending a loan from a first business entity to a second business entity utilizing a mediator, the method comprising:
identifying a first debt owed by the first business entity to the second business entity, the first debt being in an amount X due to be repaid within a time T;
facilitating the transfer of funds from the first business entity to the second business entity, the funds being in an amount Y and is due to be repaid within a time t, wherein Y≦X and the time t being no later than the time T;
reducing the amount due of the first debt by the amount Y;
establishing a second debt owed by the first business entity to the mediator, the second debt being in an amount equal to the amount Y and due to be repaid within the time T for the first debt;
establishing a third debt owed by the mediator to the first business entity, the third debt being in an amount equal to the amount Y and due to be repaid within the time t for the loan;
establishing a fourth debt owed by the mediator to the second business entity, the fourth debt being in an amount equal to the amount Y and due to be repaid within the time T for the first debt; and
establishing a fifth debt owed by the second business entity to the mediator, the fifth debt being in an amount equal to the amount Y and due to be repaid within the time t for the loan.

21. The method of claim 20 wherein, if the second business entity pays the first business entity the amount Y within time t, the third and fifth debts are purged.

22. The method of claim 20 wherein, if the second business entity fails to pay the first business entity the amount Y within time t, the second and fourth debts are purged.

23. The method of claim 20 wherein, if the second business entity pays the first business entity amount Y within time t, the amount Y is added back to the amount of the first debt and, if the second business entity and the mediator fail to pay the first business entity amount Y within time t, the amount of the first debt is reduced by the amount of the transfer.

24. The method of claim 20 wherein, if the second business entity fails to pay the first business entity the amount Y within time t, the mediator pays the first business entity the amount Y.

25. The method of claim 20 comprising charging a fee to at least one of the first business entity and second business entity, wherein at least some of the fee is paid to the mediator.

26. The method of claim 20 comprising charging interest for the second and fifth debts, and paying the interest to the moderator.

27. The method of claim 20 comprising charging interest for the third debt, and paying the interest to the first business entity

28. The method of claim 20 comprising charging interest for the fourth debt, and paying the interest to the second business entity.

29. A method for facilitating a loan between business entities utilizing a mediator, the method comprising:
identifying a set of business entities n, where n={1 . . . (N+1)} and N≧2, and wherein, for n=1 through n=N, each particular entity n owes a respective debt to entity (n+1), each respective debt being in a respective amount Xₙ that is due within a respective time Tₙ;
facilitating the transfer of funds from the n=1 entity to the n=(N+1) entity, the funds being in an amount Y and due to be repaid within a time t, wherein Y≦X and the time t is no later than the time T;
deducting the amount of the transfer Y from each respective amount Xₙ;
establishing a debt in an amount Y from the n=(N+1) entity owed to the mediator, due to be repaid within time t;
establishing a debt in an amount Y from the mediator owed to the n=1 entity, due to be repaid within time t;
establishing a debt in an amount Y from the n=1 entity owed to the mediator, due to be repaid within time T₁, wherein T₁ is the period in which the debt from the n=1 entity is due to n=2 entity;
establishing a debt in an amount Y from the mediator owed to the (N+1) entity, due to be repaid within time T_{(N+1)}, wherein T_{(N+1)} is the period in which the debt from the n=N entity is due to the n=(N+1) entity;
for each entity n=2 through n=N, establishing a debt in an amount Y, due to be repaid within a respective time Tₙ, owed by the entity to the mediator, wherein Tₙ is the period in which the debt owed by the n entity is due to the (n+1) entity; and
for each entity n=2 through n=N, establishing a debt being in an amount Y, due to be repaid within a respective time T₍ₙ₋₁₎, owed by the mediator to the entity, wherein T₍ₙ₋₁₎ is the period in which the debt owed by the (n−1) entity is due to the n entity.

30. The method of claim 29 wherein, if the n=(N+1) entity pays the n=1 entity the amount Y within time t, then for each entity n=2 through n=N, purging the debt in the amount of Y, due to be repaid in time Tₙ, owed by the entity to the mediator.

31. The method of claim 29 wherein, if the n=(N+1) entity pays the n=1 entity the amount Y within time t, the amount of the transfer is added back to each respective amount Xₙ.

32. The method of claim 29 wherein, if the n=(N+1) entity fails to pay the n=1 entity the amount Y within time t, then for each entity n=2 through n=N, purging the debt in the amount Y, due to be repaid in time T₍ₙ₋₁₎, owed by the mediator to the entity.

33. The method of claim 29 wherein, if the N=(n+1) entity and the mediator fail to pay the n=1 entity the amount Y within time t, then each respective amount Xₙ is reduced by the amount of the transfer.

34. The method of claim 29 wherein, if the n=(N+1) entity fails to pay the n=1 entity the amount Y within time t, then the mediator pays the n=1 entity the amount Y.

35. The method of claim 29 comprising charging a fee to at least one of the n entities and paying at least some of the fee to the mediator.

36. The method of claim 29 comprising charging interest for the debts from the n entities owed to the mediator and paying the mediator at least some of the interest.

37. The method of claim 29 comprising charging interest for the debts from the mediator owed to each respective entity and paying each respective entity at least some of the interest.

38. A method for nullifying a debt owed by one business entity to another business entity, the method comprising:
determining if a set of business entities n exists, where n={1 . . . N} and N≧2, and wherein, for n=1 through n=(N−1), each particular entity n owes a respective debt to entity (n+1), each debt being in a respective amount Xₙ;
identifying a debt owed by the n=N entity to the n=1 entity, the debt being in an amount Y; and
reporting the result of the determining to at least one of the n=1 entity and the n=N entity.

39. The method according to claim 38, comprising determining whether the amount Y is less than each respective amount Xₙ, wherein if Y is less than each respective amount Xₙ, then for each entity n=1 through n=N, reducing, by the amount Y, the amount owed on the debt that each entity n owes to entity n+1 and the amount owed on the debt that the n=N entity owes to the n=1 entity.

40. The method of claim 39 comprising updating accounting software of at least one of the n=1 through n=N business entities to reflect the reduced amount owed.

41. The method of claim 40 wherein updating the accounting software comprises interfacing with respective business processors associated with each entity.

42. The method of claim 38, comprising determining whether the amount Y is less than each respective amount Xₙ wherein, if Y is greater than at least one of the respective amounts Xₙ, then for each entity n=1 through n=N, reducing, by the smallest of the respective amounts Xₙ, the amount owed on the debt that each entity n owes to entity n+1 and the amount owed on the debt that the n=N entity owes to the n=1 entity.

43. The method of claim 42 comprising updating accounting software of at least one of the n=1 through n=N business entities to reflect the reduced amount owed.

44. The method of claim 43 wherein updating the accounting software comprises interfacing with respective business processors associated with each entity.

45. The method of claim 38, wherein the determining determines whether each respective amount Xₙ≧Y.

46. The method of claim 38 wherein the debt from the n=N entity to the n=1 entity carries interest owed from the n=N entity to the n=1 entity, and the debt from each n entity to the (n+1) entity carries interest owed from the n entity to the (n+1) entity.

47. The method of claim 46 wherein the debt from n=N entity owed to the n=1 entity has a term T_{N} and the debt from each n entity to the (n+1) entity has a respective term Tₙ, comprising:
determining an amount of first future interest on the debt from n=N entity owed to the n=1 entity from the current time T through the end of the term T_{N};
determining an amount of second future interest on the debt from the n=1 entity owed to the n=2 entity from the current time T through the end of the term T₁;
determining the difference between the amount of the first future interest and the amount of the second future interest; and
reporting the difference to at least one of the n=1 entity and the n=N entity.

48. The method of claim 47 comprising:
for each n entity, determining a respective amount of third future interest payable on the debt from the n entity to the (n+1) entity from the current time T through the end of term Tₙ;
for each n≧2 entity, determining a respective amount of fourth future interest receivable on the debt from the (n−1) entity to the n entity from the current time T through the end of term T₍ₙ₋₁₎;
determining the difference between the amount of a third future interest payable and the amount of a fourth future interest receivable for at least one of the n≧2 entities; and
reporting the difference to at least one of the n≧2 entities.

49. A system for identifying accounts receivable and accounts payable comprising:
one or more business processors, each associated with a respective business entity;
one or more business data stores, each coupled to a business processor and comprising accounts receivable data and accounts payable data for the business entity associated with the business processor;
one or more servers, operable to communicate with each of the business processors and to analyze accounts receivable data and accounts payable data associated with each business entity to identify a set of business entities n, where n={1 . . . (N+1)} and N≧2, wherein, for n=1 through n=N, each particular entity n owes a respective debt to entity (n+1), each respective debt being in a respective amount Xₙ that is due within a respective time Tₙ; and
one or more interface modules for modifying the accounts receivable data and accounts payable data in the one or more business data stores based on the analysis of the accounts receivable data and the accounts payable data.

50. The system of claim 49 wherein the one or more interface modules and the one or more servers are collectively operable to, for each entity n=1 through n=N, establish a loan in an amount Y from entity n to entity (n+1), each loan being due within a period of time t, wherein the amount Y is no greater than the smallest of the respective amounts Xₙ and wherein the time t is no later than the smallest of the respective times Tₙ.

51. A system for identifying accounts receivable and accounts payable comprising:
one or more business processors, each associated with a respective business entity;
one or more business data stores, each coupled to a business processor and comprising accounts receivable data and accounts payable data for the business entity associated with the business processor;
one or more servers, operable to communicate with each of the business processors and to analyze accounts receivable data and accounts payable data associated with each business entity to identify a first debt owed by a first business entity to a second business entity, the first debt being in an amount X, and to identify a second debt owed by the second business entity to the first business entity, the second being in an amount Y, wherein Y≦X; and
one or more interface modules for modifying the accounts receivable data and accounts payable data in the one or more business data stores based on the analysis of the accounts receivable data and the accounts payable data.

52. The system of claim 51 wherein the one or more servers and the one or more interface modules are collectively operable to reduce the amount owed on the first debt and the second debt by the amount of the second debt, and to reflect the reduction in the accounts receivable data and accounts payable data in the associated one or more business data stores.

53. A system for identifying accounts receivable and accounts payable comprising:
one or more business processors, each associated with a respective business entity;
one or more business data stores, each coupled to a business processor and comprising accounts receivable data and accounts payable data for the business entity associated with the business processor;
one or more servers, operable to communicate with each of the business processors and to analyze accounts receivable data and accounts payable data associated with each business entity to determine if a set of business entities n exists, where n={1 . . . N} and N≧2, wherein, for n=1 through n=(N−1), each particular entity n owes a respective debt to entity (n+1), each respective debt being in a respective amount Xₙ and to identify a debt owed by the n=N entity to the n=1 entity, the debt having an amount Y; and
one or more interface modules for modifying the accounts receivable data and accounts payable data in the one or more business data stores based on the analysis of the accounts receivable data and the accounts payable data.

54. An article comprising a machine-readable medium that stores machine-executable instructions for causing a machine to:
identify a debt owed by a first business entity to a second business entity in an amount X that is due to be repaid within a time T; and
modify the accounts receivable data and accounts payable data of the first and second business entities to reflect a loan from the first business entity to the second business entity, wherein the loan is for an amount Y and is due to be repaid within a time t, wherein Y≦X and the time t is not later than the time T.

55. The article of claim 54 wherein if the second business entity fails to repay the loan to the first business entity within time t, causing a machine to reduce the amount that the first business entity owes to the second business entity by the amount Y.

56. The article of claim 55 wherein identifying the debt comprises causing a machine to analyze the accounts payable data of the first business entity and the accounts receivable data of the second business entity.

57. The article of claim 56 wherein analyzing the respective data comprises causing a machine to interface with respective business processors associated with the first business entity and the second business entity.

58. An article comprising a machine-readable medium that stores machine-executable instructions for causing a machine to:
identify a set of business entities n, where n={1 . . . (N+1)} and N≧2, and wherein, for n=1 through n=N, each particular entity n owes a respective debt to entity (n+1), each respective debt being in a respective amount Xₙ that is due within a respective time Tₙ; and
for each entity n=1 through n=N, modify the respective accounts receivable and accounts payable data to reflect a loan in an amount Y from entity n to entity (n+1), each loan being due within a period of time t, wherein the amount Y is no greater than the smallest of the respective amounts Xₙ and wherein the time t is no later than the smallest of the respective times Tₙ.

59. The article of claim 58 wherein if entity (n+1) fails to repay the loan to entity n within time t, causing a machine to subtract the amount Y from the amount that entity n owes to entity (n+1).

60. An article comprising a machine-readable medium that stores machine-executable instructions for causing a machine to:
identify a first debt owed by the first business entity to the second business entity, the first debt being in an amount X due to be repaid within a time T, each entity having respective accounts payable data and accounts receivable data;
modify respective accounts payable data and accounts payable data to reflect the transfer of funds from the first business entity to the second business entity, the funds being in an amount Y and is due to be repaid within a time t, wherein Y≦X and the time t being no later than the time T;
modify respective accounts payable data and accounts payable data to indicate that the first debt is reduced by the amount Y;
modify respective accounts payable data and accounts payable data to reflect a second debt owed by the first business entity to the mediator, the second debt being in an amount equal to the amount Y and due to be repaid within the time T for the first debt;
modify respective accounts payable data and accounts payable data to reflect a third debt owed by the mediator to the first business entity, the third debt being in an amount equal to the amount Y and due to be repaid within the time t for the loan;
modify respective accounts payable data and accounts payable data to reflect a fourth debt owed by the mediator to the second business entity, the fourth debt being in an amount equal to the amount Y and due to be repaid within the time T for the first debt; and
modify respective accounts payable data and accounts payable data to reflect a fifth debt owed by the second business entity to the mediator, the fifth debt being in an amount equal to the amount Y and due to be repaid within the time t for the loan.

61. The article of claim 60 wherein, if the second business entity pays the first business entity the amount Y within time t, causing the third and fifth debts to be purged from the respective accounts payable data and accounts receivable data.

62. The article of claim 60 wherein, if the second business entity fails to pay the first business entity the amount Y within time t, causing the second and fourth debts to be purged from the respective accounts payable data and accounts receivable data.

63. An article comprising a machine-readable medium that stores machine-executable instructions for causing a machine to:
identify a set of business entities n, where n={1 . . . (N+1)} and N≧2, and wherein, for n=1 through n=N, each particular entity n owes a respective debt to entity (n+1), each respective debt being in a respective amount Xₙ that is due within a respective time Tₙ, each business entity having respective accounts receivable data and accounts payable data;
modify respective accounts receivable data and accounts payable data to reflect the transfer of funds from the n=1 entity to the n=(N+1) entity, the funds being in an amount Y and due to be repaid within a time t, wherein Y≦X and the time t is no later than the time T;
modify respective accounts receivable data and accounts payable data to reflect the deduction of the amount of the transfer Y from each respective amount Xₙ;
modify respective accounts receivable data and accounts payable data to reflect a debt in an amount Y from the n=(N+1) entity owed to the mediator, due to be repaid within time t;
modify respective accounts receivable data and accounts payable data to reflect a debt in an amount Y from the mediator owed to the n=1 entity, due to be repaid within time t;
modify respective accounts receivable data and accounts payable data to reflect a debt in an amount Y from the n=1 entity owed to the mediator, due to be repaid within time T₁, wherein T₁ is the period in which the debt from the n=1 entity is due to n=2 entity;
modify respective accounts receivable data and accounts payable data to reflect a debt in an amount Y from the mediator owed to the (N+1) entity, due to be repaid within time T_{(N+1)}, wherein T_{(N+1)} is the period in which the debt from the n=N entity is due to the n=(N+1) entity;
for each entity n=2 through n=N, modify respective accounts receivable data and accounts payable data to reflect a debt in an amount Y, due to be repaid within a respective time Tₙ, owed by the entity to the mediator, wherein Tₙ is the period in which the debt owed by the n entity is due to the (n+1) entity; and
for each entity n=2 through n=N, modify respective accounts receivable data and accounts payable data to reflect a debt being in an amount Y, due to be repaid within a respective time T₍ₙ₋₁₎, owed by the mediator to the entity, wherein T₍ₙ₋₁₎ is the period in which the debt owed by the (n−1) entity is due to the n entity.

64. The article of claim 63 wherein, if the n=(N+1) entity pays the n=1 entity the amount Y within time t, then for each entity n=2 through n=N, causing a machine to purge the debt in the amount of Y, due to be repaid in time Tₙ, owed by the entity to the mediator from the respective accounts receivable data and accounts payable data.

65. The article of claim 63 wherein, if the n=(N+1) entity pays the n=1 entity the amount Y within time t, causing a machine to modify the respective accounts receivable data and accounts payable data to reflect that the amount of the transfer is added back to each respective amount Xₙ.

66. The article of claim 63 wherein, if the n=(N+1) entity fails to pay the n=1 entity the amount Y within time t, then for each entity n=2 through n=N, causing a machine to reflect that the debt in the amount Y, due to be repaid in time T₍ₙ₋₁₎, owed by the mediator to the entity has been purged from the respective accounts receivable data and accounts payable data.

67. The article of claim 63 wherein, if the N=(n+1) entity and the mediator fail to pay the n=1 entity the amount Y within time t, then modifying the respective accounts receivable data and accounts payable data to reflect that each respective amount Xₙ is reduced by the amount of the transfer.

68. An article comprising a machine-readable medium that stores machine-executable instructions for causing a machine to:
identify a first debt owed by a first business entity to a second business entity, each entity having respective accounts receivable data and accounts payable data, the first debt being in an amount X, the first debt having a term T₁;
identify a second debt owed by the second business entity to the first business entity, the second debt being in an amount Y, wherein Y≦X, the second debt having a term T₂;
determine an amount of first future interest on the first debt from the current time T through the end of the term T₁;
determine an amount of second future interest on the second debt from the current time T through the end of the term T₂;
determine the difference between the amount of the first future interest and the amount of the second future interest; and
report the difference to at least one of the first business entity and the second business entity; and
modify the respective accounts payable data and accounts receivable data associated with the first business entity and second business entity to reflect that the amount owed on the first debt has been reduced by the amount of the second debt.

69. An article comprising a machine-readable medium that stores machine-executable instructions for causing a machine to:
determine if a set of business entities n exists, where n={1 . . . N} and N≧2, and wherein, for n=1 through n=(N−1), each particular entity n owes a respective debt to entity (n+1), each debt being in a respective amount Xₙ;
identify a debt owed by the n=N entity to the n=1 entity, the debt being in an amount Y; and
report the result of the determining to at least one of the n=1 entity and the n=N entity.

70. The article of claim 69, further causing a machine to determine whether the amount Y is less than each respective amount Xₙ, wherein if Y is less than each respective amount Xₙ, then for each entity n=1 through n=N, reduce, by the amount Y, the amount owed on the debt that each entity n owes to entity n+1 and the amount owed on the debt that the n=N entity owes to the n=1 entity.

71. The article of claim 70, further causing a machine to update accounting software of at least one of the n=1 through n=N business entities to reflect the reduced amount owed.

72. The article of claim 69, further causing a machine to determine whether the amount Y is less than each respective amount Xₙ wherein, if Y is greater than at least one of the respective amounts Xₙ, then for each entity n=1 through n=N, reduce, by the smallest of the respective amounts Xₙ, the amount owed on the debt that each entity n owes to entity n+1 and the amount owed on the debt that the n=N entity owes to the n=1 entity.

73. The article of claim 72, further causing a machine to update accounting software of at least one of the n=1 through n=N business entities to reflect the reduced amount owed.

74. The article of claim 69 wherein the debt from n=N entity owed to the n=1 entity has a term T_{N} and the debt from each n entity to the (n+1) entity has a respective term Tₙ, further causing a machine to:
determine an amount of first future interest on the debt from n=N entity owed to the n=1 entity from the current time T through the end of the term T_{N};
determine an amount of second future interest on the debt from the n=1 entity owed to the n=2 entity from the current time T through the end of the term T₁;
determine the difference between the amount of the first future interest and the amount of the second future interest; and
report the difference to at least one of the n=1 entity and the n=N entity.

75. The article of claim 74, further causing a machine to:
for each n entity, determine a respective amount of third future interest payable on the debt from the n entity to the (n+1) entity from the current time T through the end of term Tₙ;
for each n≧2 entity, determine a respective amount of fourth future interest receivable on the debt from the (n−1) entity to the n entity from the current time T through the end of term T₍ₙ₋₁₎;
determine the difference between the amount of a third future interest payable and the amount of a fourth future interest receivable for at least one of the n≧2 entities; and
report the difference to at least one of the n≧2 entities.
